(19) United States
(12) Patent Application Publication
(10) Pub. No.: US 2017/0130152 A1
(43) Pub. Date: May 11, 2017

(54) APPARATUS FOR ADJUSTING STEAM PRESSURE IN A SYSTEM FOR DRYING COAL USING REHEAT STEAM

(71) Applicant: HANKOOK TECHNOLOGY INC., Seoul (KR)

(72) Inventor: Sung Kon KIM, Anyang-si, Gyeonggi-do (KR)

(21) Appl. No.: 15/320,137

(22) PCT Filed: Jun. 17, 2015
(86) PCT No.: PCT/KR2015/006142

§ 371 Date: Dec. 19, 2016

(30) Foreign Application Priority Data
Jun. 17, 2014 (KR) 10-2014-0073213
Jun. 17, 2014 (KR) 10-2014-0073216
Jun. 17, 2014 (KR) 10-2014-0073221
Jun. 17, 2014 (KR) 10-2014-0073223
Jan. 2, 2015 (KR) 10-2015-0000084
Jan. 2, 2015 (KR) 10-2015-0000093

(51) Int. Cl. C10L 9/00; F26B 21/02; F26B 17/04; F26B 23/00; F26B 3/04; F26B 17/02

(52) U.S. Cl. CPC C10L 9/00; F26B 3/04; F26B 17/026; F26B 17/04; F26B 23/002; F26B 21/02; C10L 2290/08

(57) ABSTRACT

The present invention relates to a system for drying coal using reheat steam, and more particularly, to an apparatus for enhancing drying efficiency by adjusting reheat steam to be injected to coal input and transferred onto a transfer device at predetermined pressure in a multi-stage dryer drying the coal by using reheat steam and in the apparatus for adjusting steam pressure in a system for drying coal using reheat steam, a steam supply pipe supplying the reheat steam generated by a reheater is connected to one side of each of the first steam chamber, the second steam chamber, the third steam chamber, and the fourth steam chamber and a first steam distribution perforated plate with a plurality of steam injection holes is coupled to and installed in the inner upper part of each of the first steam chamber, the second steam chamber, the third steam chamber, and the fourth steam chamber to inject the reheat steam at uniform pressure through the first steam injection holes.

### TECHNICAL FIELD

The present invention relates to a system for drying coal using reheat steam, and more particularly, to an apparatus for enhancing drying efficiency by adjusting reheat steam to be injected to coal input and transferred onto a transfer device at predetermined pressure in a multi-stage dryer drying the coal by using reheat steam.

### BACKGROUND ART

In general, a thermal power plant generating power by using coal as fuel combusts coal of approximately 180 ton/hr per 500 MW and supplies coal equivalent to approximately 37 ton per one pulverizer to a boiler. In the 500 MW thermal power plant using the coal, approximately 6 coal storages having a capacity of approximately 500 ton are installed and in 5 coal storages, the coal is normally supplied and one remaining coal storage is operated as a coal yard capable of reserving coal which may be preliminarily used during a predetermined period.

Moreover, in the thermal power plant using the coal as the fuel, a standard thermal power design criterion for the coal is designed to use low-moisture bituminous coal of 6,080 Kcal/Kg and 10% or less. In some thermal power plant, imported coal is used and some bituminous coal among the imported coal average moisture content of 17% or more may be provided to decrease combustion efficiency of the boiler. When a calorific value of coal using 5,400 Kcal/Kg as a standard thermal power combustion limit is low, it is anticipated that a power generation amount decreases and fuel consumption increases due to the decrease in combustion efficiency. Moreover, when subbituminous coal which is high-moisture low calorific coal is used, a moisture content is higher than a design criterion, and as a result, a transport system transporting the coal is not smooth and when the coal is pulverized by the pulverizer, efficiency decreases and the combustion efficiency decreases due to partial incomplete combustion, and unbalance of heat distribution, which occurs in the boiler and the boiler may also operate in an abnormal state. However, in the thermal power plant, a use weight of the subbituminous coal gradually increases up to approximately 41 to 60% in order to reduce fuel cost.

Further, preference to the thermal power plant increases due to anticipations of a global business recovery and confronting a safety problem due to breakage of a nuclear power plant by a big earthquake of Japan, and as a result, it is expected that the demand and cost of the coal will continuously increase. As an environment of a global coal market is changed from a consumer to a supplier, stable supply and demand of the coal are actually difficult and a yield of the high caloric coal is prospected to be maintained at a current level, and as a result, the unbalance of the supply and demand of the coal is anticipated.

The low caloric coal in total global coal deposits is approximately 47% and the deposits are large, but the caloric value is small and the moisture content is high, and as a result, it is difficult to completely combust the high-moisture low caloric coal due to a combustion failure, and the like during combustion. Therefore, the high-moisture low caloric coal is disregarded on the market. Globally, a tendency to depend on a stable price of petroleum and low-priced production cost of the nuclear power generation has been high in recent years, but construction of a lot of thermal power plants using the coal has been planned due to a rapid increase of a petroleum price and anxiety about the nuclear power generation in recent years.

As a technique (thermal drying) that dries the coal in the related art, a rotary drying method that dries coal particles in a cylindrical shell with high-temperature gas while rotating the cylindrical shell into which the coal is input, a flash (pneumatic) drying method that dries the coal by lifting the high-temperature dry gas from the bottom to the top while supplying the coal from the top to the bottom, and a fluid-bed drying method that dries the coal while the high-temperature dry gas is lifted up while accompanying minute particles are primarily used.

The coal is divided into surface moisture attached to a porosity between the coal particles and coupling moisture coupled to air holes in the coal. As the surface moisture, most moisture sprayed during a washing process, and transport and storage in a district and the amount of the surface moisture is determined according to a surface area and absorptiveness and as the particles are smaller, the surface area increases and a capillary is formed between the particles to contain the moisture, thereby increasing the moisture content. The coupling moisture is formed at a generation time of the coal and the amount of the coupling moisture is the smaller in the order of brown coal, soft coal (bituminous coal and subbituminous coal), and anthracite coal. When the coal has much moisture, the caloric value decreases and transport cost increases, and as a result, controlling the moisture is required during processes such as mixture, pulverization, separation, and the like of the coal.

Moreover, in a multi-stage dryer, that is, a device that dries the coal by spaying high-temperature reheat steam below a dryer while transporting the pulverized coal through a conveyor with a plurality of through-holes through which reheat steam passes or a plurality of coupled transport plates, since the reheat steam is not injected to the coal input onto the transfer plate at uniform pressure, the moisture included in the coal cannot be effectively dried. As a result, the number of stages and the length of the dryer for drying the coal needs to be increased and a supply amount of the reheat steam for drying increases, cost and time required for drying the coal increase.

As prior art associated with the present invention, Korean Patent Registration No. 10-1216827 discloses that a steam conveyor belt transferring coal is installed in a duct of an overheat steam drying system, an overheat steam supply pipe is connected to the duct, and overheat steam is injected onto the transferred coal from an overheat steam injection pipe. However, the overheat steam is injected only on the surface of the coal input onto the steam conveyor belt or the overheat steam is not effectively injected up to a coal particle or a porosity in a part where the coal is crumpled or a density is high, and as a result, drying efficiency may deteriorate.

### DISCLOSURE

### Technical Problem

An embodiment of the present invention is directed to effectively dry coal by injecting reheat steam the coal at uniform pressure while coal input into a dryer is transferred to a transfer device in a coal drying system that dries the coal using reheat steam while transferring coal used as fuel of a thermal power plant.

Another embodiment of the present invention is directed to reduce fuel consumption by maintaining an optimum water content of coal due to effective drying of coal to enhance a calorific value of coal and improving combustion efficiency of a boiler of the thermal power plant.

Yet embodiment of the present invention is directed to provide a drying technology to prevent environmental problems due to incomplete combustion of coal by controlling moisture contained in coal and a technology applied to the thermal power plant.

### Technical Solution

According to an aspect of the present invention, provided is an apparatus for adjusting steam pressure in a system for drying coal using reheat steam including a first coal dryer in which a pair of first drive sprockets and a pair of first driven sprockets are spaced apart from each other at a predetermined distance to be fastened to first chains, respectively, a plurality of transfer plates is hinge-coupled between the first chains, a pair of first guide rails horizontally supporting the first transfer plate is installed below an upper second chain connected between the first drive sprocket and the first driven sprocket, a pair of second guide rails horizontally supporting the first transfer plate is installed below a lower first chain connected between the first drive sprocket and the first driven sprocket, a first steam chamber injecting reheat steam supplied from a reheater is installed below the upper first chain, a second steam chamber injecting reheat steam supplied from the reheater is installed below the lower first chain, a first exhaust gas chamber collecting exhaust gas is installed on the upper first chain, and a second exhaust gas chamber collecting exhaust gas is installed on the lower first chain, and a second coal dryer in which a pair of second drive sprockets and a pair of second driven sprockets are spaced apart from each other at a predetermined distance to be fastened to second chains, respectively, a plurality of transfer plates is hinge-coupled between the second chains, a pair of second guide rails horizontally supporting the second transfer plate is installed below an upper second chain connected between the second drive sprocket and the second driven sprocket, a pair of second guide rails horizontally supporting the second transfer plate is installed below a lower second chain connected between the second drive sprocket and the second driven sprocket, a third steam chamber injecting reheat steam supplied from the reheater is installed below the upper second chain, a fourth steam chamber injecting reheat steam supplied from the reheater is installed below the lower second chain, a third exhaust gas chamber collecting exhaust gas is installed on the upper second chain, and a fourth exhaust gas chamber collecting exhaust gas is installed on the lower second chain, coal which is primarily dried in the first coal dryer being inputted into the second coal dryer and thus secondarily dried, wherein a steam supply pipe supplying the reheat steam generated by a reheater is connected to one side of each of the first steam chamber, the second steam chamber, the third steam chamber, and the fourth steam chamber and a first steam distribution perforated plate with a plurality of steam injection holes is coupled to and installed in the inner upper part of each of the first steam chamber, the second steam chamber, the third steam chamber, and the fourth steam chamber to inject the reheat steam at uniform pressure through the first steam injection holes.

According to another aspect of the present invention, provided is an apparatus for adjusting steam pressure in a system for drying coal using reheat steam including a first coal dryer in which a pair of first drive sprockets and a pair of first driven sprockets are spaced apart from each other at a predetermined distance to be fastened to first chains, respectively, a plurality of transfer plates is hinge-coupled between the first chains, a pair of first guide rails horizontally supporting the first transfer plate is installed below an upper second chain connected between the first drive sprocket and the first driven sprocket, a pair of second guide rails horizontally supporting the first transfer plate is installed below a lower first chain connected between the first drive sprocket and the first driven sprocket, a first steam chamber injecting reheat steam supplied from a reheater is installed below the upper first chain, a second steam chamber injecting reheat steam supplied from the reheater is installed below the lower first chain, a first exhaust gas chamber collecting exhaust gas is installed on the upper first chain, and a second exhaust gas chamber collecting exhaust gas is installed on the lower first chain, a second coal dryer in which a pair of second drive sprockets and a pair of second driven sprockets are spaced apart from each other at a predetermined distance to be fastened to second chains, respectively, a plurality of transfer plates is hinge-coupled between the second chains, a pair of second guide rails horizontally supporting the second transfer plate is installed below an upper second chain connected between the second drive sprocket and the second driven sprocket, a pair of second guide rails horizontally supporting the second transfer plate is installed below a lower second chain connected between the second drive sprocket and the second driven sprocket, a third steam chamber injecting reheat steam supplied from the reheater is installed below the upper second chain, a fourth steam chamber injecting reheat steam supplied from the reheater is installed below the lower second chain, a third exhaust gas chamber collecting exhaust gas is installed on the upper second chain, and a fourth exhaust gas chamber collecting exhaust gas is installed on the lower second chain, and a coal constant feeder including a first transfer roller hinge-coupled between two-side centers of the first transfer plate and the first chains, respectively, at left and right sides of the first transfer roller, first auxiliary rollers hinge-coupled with the sides of the first transfer plate, respectively, second transfer rollers hinge-coupled between both centers of the second transfer plate and the second chains, respectively, at left and right sides of the second transfer roller, second auxiliary rollers hinge-coupled with the sides of the second transfer plate, respectively, a first guide bar rotating and up-supporting the lower first transfer plate separated from the second guide rail in one direction installed from the top to the bottom of the first drive sprocket along the side, a second guide bar rotating and down-supporting the upper first transfer plate separated from the first guide rail installed from the bottom to the top of the first driven sprocket along the side, a third guide bar rotating and up-supporting the lower second transfer plate separated from the fourth guide rail in one direction installed from the top to the bottom of the second drive sprocket along the side, and a fourth guide bar rotating and down-supporting the upper second transfer plate separated from the third guide rail installed from the bottom to the top of the second driven sprocket along the side and supplying coal of a predetermined amount onto the upward surface of the first transfer plate, coal which is primarily dried in the first coal dryer being inputted into the second coal dryer and thus secondarily dried, wherein a steam supply pipe supplying the reheat steam generated by a reheater is connected to one side of each of the first steam chamber, the second steam chamber, the third steam chamber, and the fourth steam chamber and a first steam distribution perforated plate with a plurality of steam injection holes is coupled to and installed in the inner upper part of each of the first steam chamber, the second steam chamber, the third steam chamber, and the fourth steam chamber to inject the reheat steam at uniform pressure through the first steam injection holes.

Further, in the present invention, a perforation ratio of the first steam injection holes to an entire area of the first steam distribution perforated plate may be 10 to 15%. In addition, in the present invention, a first stopper horizontally supporting the first steam distribution perforated plate may be installed on each of the inner walls of the first to fourth steam chambers to protrude.

Moreover, in the present invention, a first support member may be fixed to a first fixation member provided on the bottom of the first steam distribution perforated plate installed inside each of the first to fourth steam chambers, a second support member may be fixed to a second fixation member provided on the bottom inside each of the first to fourth steam chambers, a plurality of elastic supports to which an elastic body having elastic force having a predetermined magnitude is coupled may be installed between the first support member and the second support member, the first elastic support may be installed to support the first steam distribution perforated plate to form the first space part with the first to fourth steam chambers and the first steam distribution perforated plate is lifted with steam pressure which flows in the first space part to constantly maintain reheat steam injection pressure through the first steam injection holes.

In addition, in the present invention, a pocket may cover the outer periphery of the first elastic support.

Further, in the present invention, a second steam distribution perforated plate where a plurality of second steam injection holes is formed to penetrate may be installed on the top or the bottom of the first steam distribution perforated plate installed in each of the first to fourth steam chambers.

Moreover, in the present invention, the perforation ratio of the second steam injection holes to the entire area of the first steam distribution perforated plate may be 10 to 15%. In addition, in the present invention, a second stopper horizontally supporting the second steam distribution perforated plate may be installed on each of the inner walls of the first to fourth steam chambers to protrude.

Further, in the present invention, a first support member may be fixed to a third fixation member provided on the bottom of the second steam distribution perforated plate, a second support member may be fixed to a fourth fixation member provided on the surface of the first steam distribution perforated plate, a plurality of second elastic supports to which an elastic body having elastic force having a predetermined magnitude is coupled may be installed between the first support member and the second support member, the second elastic support may be installed to support the second steam distribution perforated plate to form the second space part with the first steam distribution perforated plate, and the second steam distribution perforated plate is lifted with steam pressure which flows in the second space part to constantly maintain reheat steam injection pressure through the second steam injection holes.

In addition, in the present invention, the pocket may cover the outer periphery of the second elastic support.

Further, in the present invention, guards may be integrally coupled to left and right tops of the transfer plates, shield plates may be integrally coupled to left and right bottoms of the transfer plates, one side of a steam pressure adjuster having elasticity may be fixedly installed on each of both side walls of the steam chamber installed below the transfer plates, and when the steam pressure of the reheat steam transferred from the steam chamber is equal to or more than the predetermined pressure while the surface of the steam pressure adjuster contact the bottoms of the shield plates, the steam pressure presses the steam pressure adjuster having the elasticity to discharge the reheat steam between the steam pressure adjuster and the shield plates.

In addition, in the present invention, the steam pressure adjuster may be constituted by an elastic member having the elasticity in a plate shape or a U shape.

Further, in the present invention, the steam pressure adjuster may be hinge-coupled to a fixation plate of which one side is fixed to each of both side walls of the steam chamber, an operation plate of which the surface contacts the bottom of the shield plate, and the other side of the fixation plate and one side of the operation plate to be elastically supported by a spring.

Moreover, in the present invention, a steam pressure adjuster may be installed, in which a guide plate in which guards are integrally coupled to the left and right tops of the transfer plates, the shield plates are integrally coupled to the left and right bottoms of the transfer plates, one side is fixedly installed on each of both side walls of the steam chamber installed below the transfer plates, a long hole is formed at the center, and a plurality of through-holes are formed at both sides of the long hole at a predetermined interval, an operation member installed on the top of the guide plate to contact the shield plates, an elevation plate formed to protrude downward on the bottom of the operation member and elevated while being inserted into the long hole, and a plurality of guide rods formed to protrude downward on the bottom of the operation member and elevated while being inserted into the through-hole and elastically supported by the spring between the bottom of the operation member and the surface of the guide plate are coupled to each other, and when the steam pressure of the reheat steam transferred from the steam chamber is equal to or more than the predetermined pressure while the surface of the steam pressure adjuster contact the bottoms of the shield plates, the steam pressure presses the steam pressure adjuster having the elasticity to discharge the reheat steam between the steam pressure adjuster and the shield plates, thereby adjusting the steam pressure at predetermined pressure or more.

Further, in the present invention, one surface of the operation member may contact the side wall of the steam chamber.

Moreover, in the present invention, an interruption protrusion may be installed to protrude in an outside horizontal direction on the side wall of the steam chamber and the interruption protrusion contacts the side of the operation member.

Further, in the present invention, the apparatus may further include a first injection cap coupled to the respective through-holes on the first transfer plate to protrude in a cylindrical shape, having one or more first injection holes formed to penetrate on the top thereof, and a plurality of second injection holes formed to penetrate on the side thereof; and a second injection cap coupled to the respective through-holes formed on the second transfer plate to protrude in the cylindrical shape, having one or more first injection holes formed to penetrate on the top thereof, and a plurality of second injection holes formed to penetrate on the side thereof, wherein the first injection cap disperses and injects the reheat steam injected by each of the first steam chamber and the second steam chamber to the top and the side by penetrating a coal pile loaded and transferred onto the upward surface of the upper and lower first transfer plates, and the second injection cap disperses and injects the reheat steam injected by each of the third steam chamber and the fourth steam chamber to the top and the side by penetrating the coal pile loaded and transferred onto the upward surface of the upper and lower second transfer plates.

In addition, in the present invention, pressure maintaining member dispersing the pressure of the reheat steam into the first injection cap and the second injection cap may be coupled to each support piece.

Further, in the present invention, a plurality of branched distribution steam supply pipes may be connected to the first to fourth steam chambers.

### Advantageous Effects

According to the present invention, incomplete combustion of coal is prevented by removing moisture which remains on the surface and to the inside of coal which is used fuel of a thermal power plant by injecting high-temperature reheat steam onto the surface of the coal and to the inside of the coal at uniform pressure in a multi-stage coal dryer to enhance a caloric value of the coal and minimize emission of pollutant materials, prevent corrosion and durability of a system, reduce spontaneous ignition rate depending on reduction of moisture, enhance pulverization efficiency of a coal pulverizer and a thermal distribution of a power generation boiler when the coal is combusted, resolve a movement passage clogging phenomenon, and enhance stability of coal supply by increasing utilization of low-grade coal having a small demand. Further, it is possible to use low calorific coal which is cheaper than high calorific coal, reduce fuel costs and costs due to reduction in coal import amount, and reduce emission of waste and pollutants generated from exhaust gas and reduce carbon dioxide by relatively decreasing coal consumption.

### BRIEF DESCRIPTION OF THE DRAWINGS

FIG. 1 is a block diagram illustrating a system for drying coal using reheat steam according to the present invention.

FIG. 2 is a configuration diagram illustrating the front side of the system for drying coal using reheat steam according to the present invention.

FIG. 3 is a configuration diagram illustrating the side of the system for drying coal using reheat steam according to the present invention.

FIG. 4 is a perspective view illustrating a main part where a reheat steam supply chamber is installed in the system for drying coal using reheat steam according to the present invention.

FIG. 5 is a perspective view illustrating a reheat steam supply chamber in the system for drying coal using reheat steam, as a first embodiment of the present invention.

FIG. 6 is a cross-sectional view illustrating an operation of the reheat steam supply chamber according to the present invention.

FIG. 7 is a perspective view illustrating the reheat steam supply chamber as a modified example according to the present invention.

FIG. 8 is a cross-sectional view illustrating an operation of FIG. 7.

FIG. 9 is a perspective view illustrating that a distribution steam supply pipe is connected to the reheat steam supply chamber according to the present invention. FIG. 10 is a perspective view illustrating a main part where a reheat steam supply chamber in a system for drying coal using reheat steam, as a second embodiment of the present invention.

FIG. 11 is a perspective view illustrating an elastic support operation of the reheat steam supply chamber according to the present invention.

FIGS. 12a and 12b are cross-sectional views illustrating an operation of the reheat steam supply chamber according to the present invention.

FIG. 13 is a cross-sectional view illustrating the reheat steam supply chamber as a modified example according to the present invention.

FIG. 14 is a perspective view illustrating that a steam pressure adjuster is installed in a reheat steam supply chamber in a system for drying coal using reheat steam, as a third embodiment of the present invention.

FIG. 15 is a side view illustrating the coal drying system in which the reheat steam supply chamber is installed in the reheat steam supply chamber according to the present invention.

FIGS. 16a and 16b are cross-sectional views illustrating an operation of the steam pressure adjuster installed in the reheat steam supply chamber according to the present invention.

FIG. 17 is a cross-sectional view illustrating that the steam pressure adjuster is installed in the reheat steam supply chamber as a modified example according to the present invention.

FIGS. 18a and 18b are cross-sectional views illustrating an operation of the steam pressure adjuster installed in the reheat steam supply chamber according to the present invention.

FIG. 19 is a cross-sectional view illustrating that the steam pressure adjuster is installed in the reheat steam supply chamber as a modified example according to the present invention.

FIGS. 20a and 20b are cross-sectional views illustrating an operation of the steam pressure adjuster installed in the reheat steam supply chamber according to the present invention.

FIG. 21 is a perspective view illustrating that a steam pressure adjuster is installed in a reheat steam supply chamber in a system for drying coal using reheat steam, as a fourth embodiment of the present invention.

FIG. 22 is a side view illustrating the coal drying system in which the reheat steam supply chamber is installed in the reheat steam supply chamber according to the present invention.

FIGS. 23a and 23b are cross-sectional views illustrating an operation of the steam pressure adjuster installed in the reheat steam supply chamber according to the present invention.

FIGS. 24 and 25 are cross-sectional views illustrating modified examples of the steam pressure adjuster installed in the reheat steam supply chamber according to the present invention, respectively.

FIGS. 26 and 27 are perspective views illustrating a main part where a transfer plate coupled with an injection cap and a reheat steam supply chamber are installed in a system for drying coal using reheat steam, as a fifth embodiment of the present invention.

FIG. 28 is a perspective view of the injection cap coupled to the transfer plate according to the present invention.

FIG. 29a is a cross-sectional view illustrating the injection cap coupled to the transfer plate according to the present invention and FIG. 29b is a cross-sectional view illustrating an operation of the injection cap.

FIG. 30 is a perspective view illustrating another example of the injection cap coupled to the transfer plate according to the present invention.

FIGS. 31 and 32 are perspective views illustrating a main part where a reheat steam supply chamber is installed in a system for drying coal using reheat steam, as a sixth embodiment of the present invention.

FIG. 33 is an exploded perspective view illustrating a main part of a transfer device in the system for drying coal using reheat steam according to the present invention.

FIGS. 34 and 35 are cross-sectional views illustrating an operation of the transfer device in the system for drying coal using reheat steam according to the present invention, respectively.

### BEST MODE FOR THE INVENTION

Hereinafter, an apparatus for adjusting steam pressure in a system for drying coal using reheat steam according to the present invention will be described in detail with reference to the accompanying drawings.

According to the present invention, reheat steam at uniform pressure is injected to coal having a predetermined moisture content, which is input onto a transfer device in which a plurality of through-holes is formed to penetrate when the coal is dried while being transferred by using the transfer device such as a conveyor or a transfer plate to increase a drying effect of the coal. Moreover, a steam chamber that supplies the reheat steam is installed below the transfer device of the coal drying system and injects high-temperature reheat steam generated and supplied by a reheater at predetermined pressure while pulverized coal is transferred to the transfer device to dry the coal.

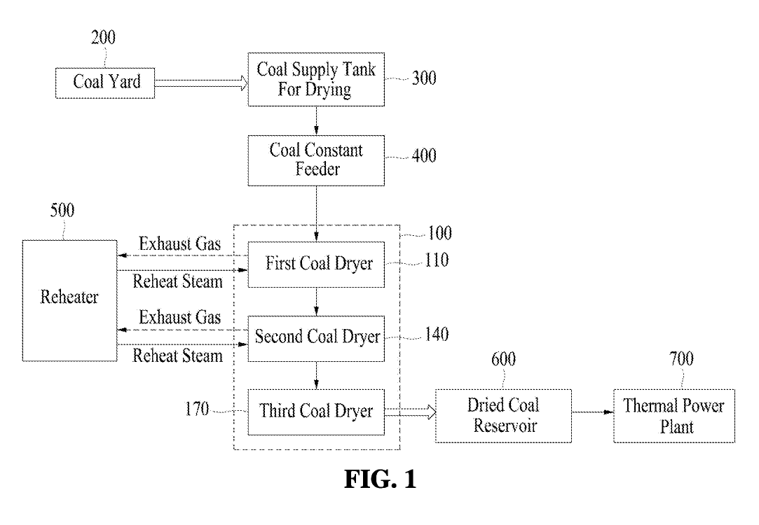

In FIG. 1, a coal yard 200 keeps and stores coal used as boiler fuel of a thermal power plant. The coal contains surface moisture and internal moisture. Further, the coal stored in the coal yard 200 is periodically sprayed with water to prevent scattering of coal dust. The coal stored in the coal yard 200 is transferred to a coal drying system 100 through a transfer means such as a conveyor system. In this case, the coal in the coal yard 10 from which the moisture is removed may be transferred and stored into a coal supply tank 300 for drying connected with the coal drying system. In addition, the coal stored in the coal supply tank 300 is supplied to the coal drying system 100 from a coal constant feeder 400 with a predetermined amount. The coal drying system 100 includes a third coal dryer 170 for naturally drying the coal discharged through a first coal dryer 110 and a second coal dryer 170 installed in multiple layers. The first coal dryer 110 and the second coal dryer 140 have substantially the same structure. The coal naturally dried through the third coal dryer 170 is stored in a dried coal reservoir 600 and then, supplied as boiler fuel of a thermal power plant 700.

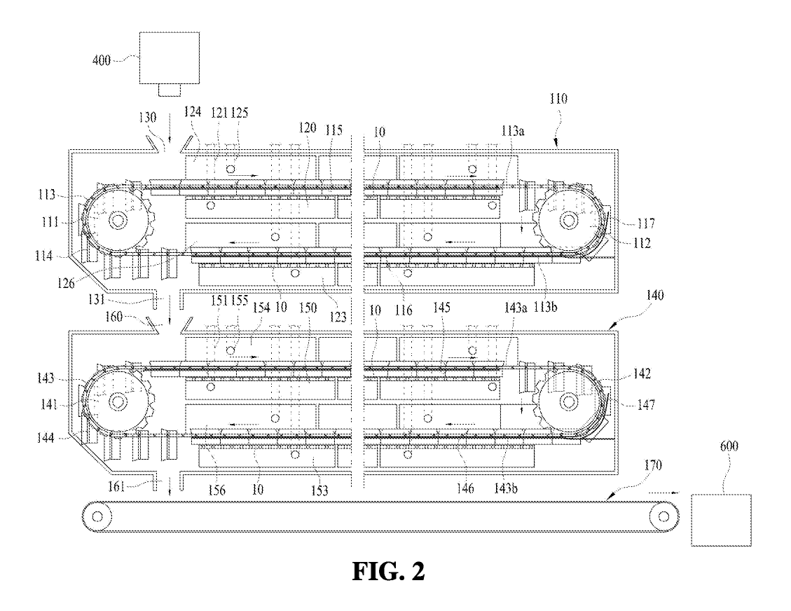

FIG. 2 illustrates an example of a coal drying system 100 in which a steam chamber supplying reheat steam is installed in the system for drying coal according to the present invention. The coal drying system 100 includes a multi-stage dryer, that is, the first coal dryer 110 drying the coal input from the coal constant feeder 400, the second coal dryer 140 secondarily drying the coal dried by the first coal dryer, and the third coal dryer 170 naturally drying the coal dried by the second coal dryer and then, supplying the dried coal to the dried coal reservoir 600.

In the first coal dryer 110, a pair of first drive sprockets 111 and a pair of first driven sprockets 112 are spaced apart from each other at a predetermined distance to be fastened to first chains 113, respectively, a plurality of transfer plates 114 is hinge-coupled between the first chains 113, a pair of first guide rails 115 horizontally supporting the first transfer plate 114 is installed below an upper second chain 143 connected between the first drive sprocket 111 and the first driven sprocket 112, a pair of second guide rails 116 horizontally supporting the first transfer plate 114 is installed below a lower first chain 113 connected between the first drive sprocket 111 and the first driven sprocket 112, a first steam chamber 120 injecting reheat steam supplied from a reheater 500 is installed below the upper first chain 113, a second steam chamber 123 injecting reheat steam supplied from the reheater 500 is installed below the lower first chain 113, a first exhaust gas chamber 124 collecting exhaust gas is installed on the upper first chain 113, and a second exhaust gas chamber 126 collecting exhaust gas is installed on the lower first chain 113.

In addition, in the second coal dryer 140, a pair of second drive sprockets 141 and a pair of second driven sprockets 142 are spaced apart from each other at a predetermined distance to be fastened to second chains 143, respectively, a plurality of transfer plates 144 is hinge-coupled between the second chains 143, a pair of second guide rails 145 horizontally supporting the second transfer plate 144 is installed below an upper second chain 143 connected between the second drive sprocket 141 and the second driven sprocket 142, a pair of second guide rails 146 horizontally supporting the second transfer plate 144 is installed below a lower second chain 143 connected between the second drive sprocket 141 and the second driven sprocket 142, a third steam chamber 150 injecting reheat steam supplied from the reheater 500 is installed below the upper second chain 143, a fourth steam chamber 153 injecting reheat steam supplied from the reheater 500 is installed below the lower second chain 143, a third exhaust gas chamber 154 collecting exhaust gas is installed on the upper second chain 143, and a fourth exhaust gas chamber 156 collecting exhaust gas is installed on the lower second chain 143.

Therefore, in the present invention, the steam supply pipe 121 supplying hot reheat steam generated from the reheater 500 is connected to one side of the first steam chamber 120 and the second steam chamber 123, and the steam supply pipe 151 supplying hot reheat steam generated from the reheater 500 is connected to one side of the third steam chamber 150 and the fourth steam chamber 153. In addition, a perforated plate 10 for first steam distribution through-formed with a plurality of first steam injection holes 11 is installed on the inside of each of the first steam chamber 120, the second steam chamber 123, the third steam chamber 150, and the fourth steam chamber 153. In each of the first steam chamber 120 to the fourth steam chamber 153, the reheat steam having uniform pressure is injected through the first steam injection holes 11.

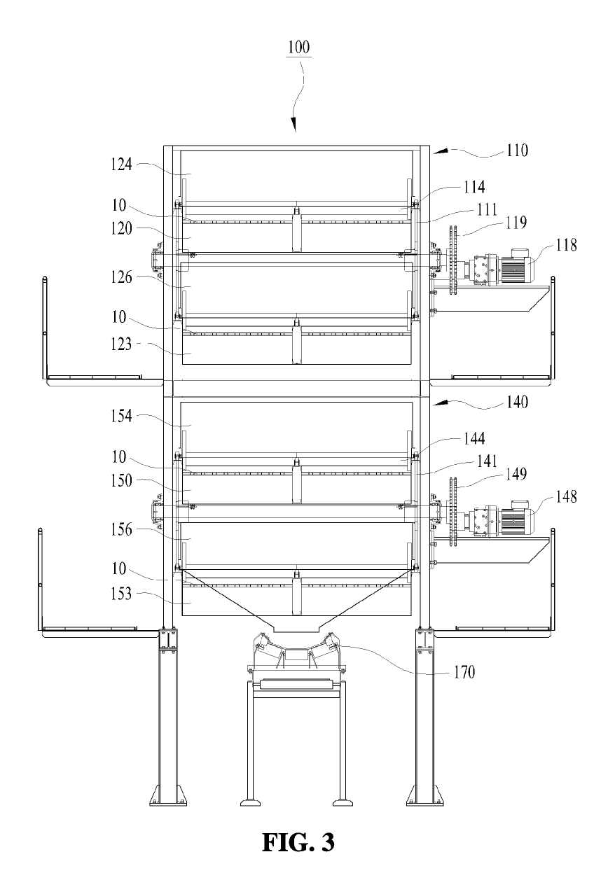

In FIG. 3, the first steam chamber 120 is installed below the first guide rail 115 and the second steam chamber 124 is installed below the second guide rail 116. Moreover, the third steam chamber 150 is installed below the third guide rail 145 and the fourth steam chamber 153 is installed below the fourth guide rail 146. One or more first steam chambers 120 to fourth steam chambers 153 may be partitioned and installed.

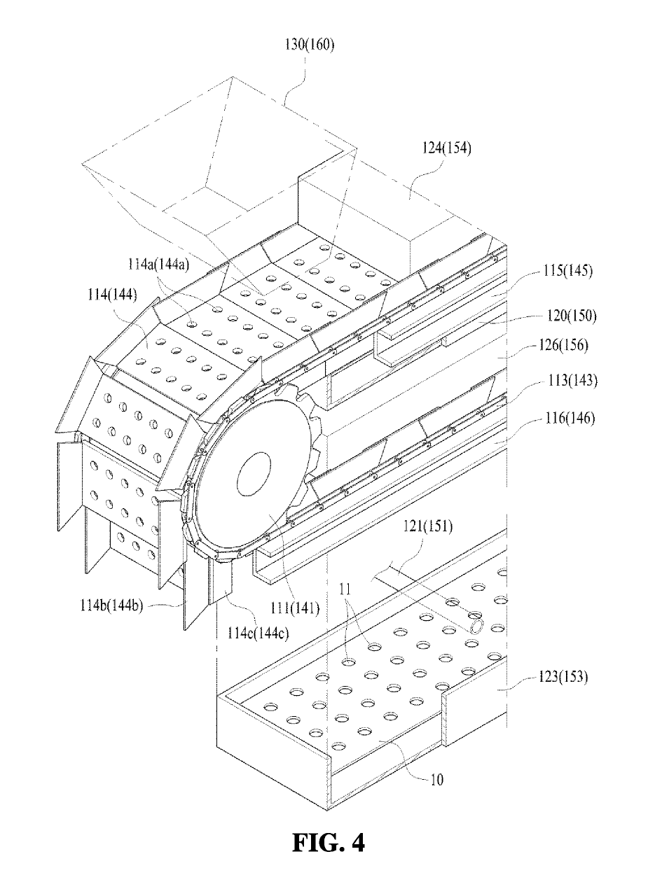

Further, in FIG. 4, a first exhaust gas chamber 124 is installed on the first guide rail 115, a second exhaust gas chamber 126 is installed on the second guide rail 116, a third gas chamber 154 is installed on the third guide rail 145, and a fourth gas chamber 156 is installed on the fourth guide rail 146. One or more first exhaust gas chambers 124 to fourth exhaust gas chambers 156 may be partitioned and installed. The first exhaust gas chamber 124 to the fourth exhaust gas chamber 156 collect exhaust gas injected and thereafter, changed in the first steam chamber 120 to the fourth steam chamber 156, respectively and thereafter, discharged to the outside through the first gas discharge pipe 125 or the second gas discharge pipe 155.

In the first transfer plate 114, a plurality of through-holes 114a is formed so that the reheat steam injected from the first steam chamber 120 and the second steam chamber 123 passes through the first transfer plate 114 to contact coal particles. At upper left and right sides of the first transfer plate 114, a guard 114b having a predetermined height is installed to prevent the input coal pile from flowing in a left or right direction of the first transfer plate 114. The guard 114b has a shape that is wide at the top and narrow at the bottom as a substantially trapezoidal shape. Accordingly, the top of the guard 114b of the first transfer plate 114 is overlapped with an adjacent guard 114b. In this case, the guard 114b of the first transfer plate 114 is installed in a substantially zigzag direction with the adjacent guard 114b. Further, at lower left and right sides of the first transfer plate 114, shield plates 114c are installed to prevent the reheat steam injected from the first steam chamber 120 and the second steam chamber 123 from being lost when injected to left and right sides of each of the first steam chamber 120 and the second steam chamber 123.

In addition, in the second transfer plate 144, a plurality of through-holes 144a is formed so that the reheat steam injected from the third steam chamber 150 and the fourth steam chamber 153 passes through the second transfer plate 144 to contact coal particles. At upper left and right sides of the second transfer plate 144, guards 144b having a predetermined height are installed to prevent the input coal pile from flowing in a left or right direction of the second transfer plate 144. The guard 144b has a shape that is narrow at the top and widened at the bottom as the substantially trapezoidal shape. Accordingly, the top of the guard 144b of the second transfer plate 144 is overlapped with an adjacent guard 144b. In this case, the guard 144b of the second transfer plate 144 may be installed in the substantially zigzag direction with the adjacent guard 144b. Further, at lower left and right sides of the second transfer plate 144, shield plates 144c are installed to prevent the reheat steam injected from the third steam chamber 150 and the fourth steam chamber 153 from being lost when injected to left and right sides of each of the third steam chamber 150 and the fourth steam chamber 153.

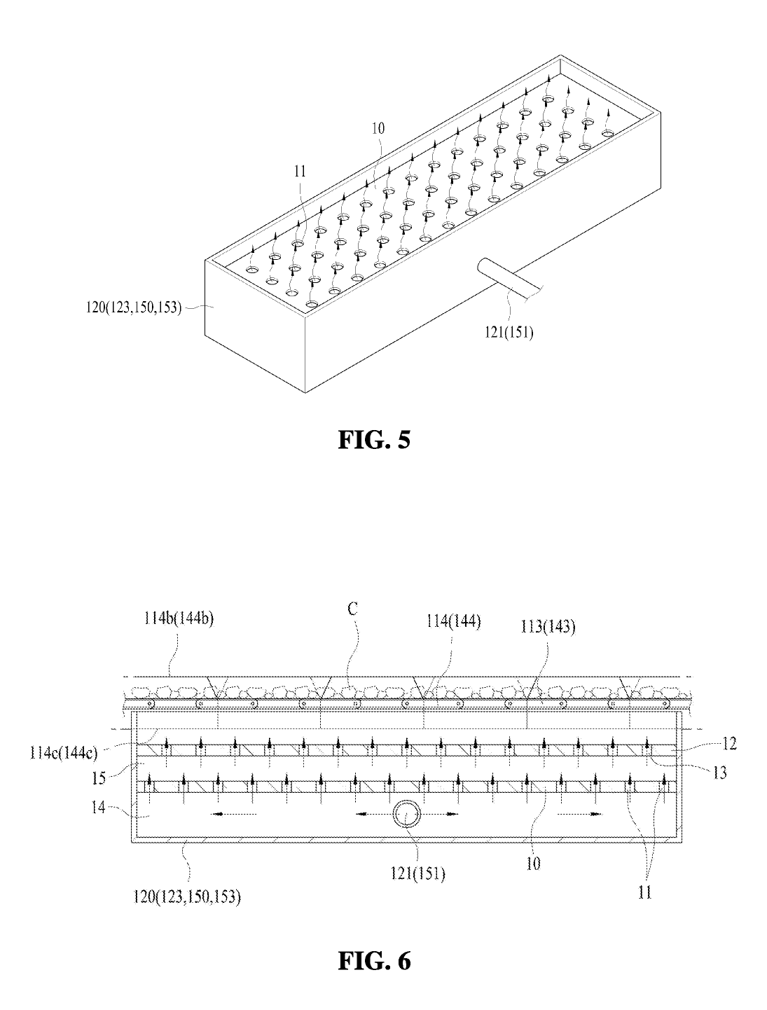

A first embodiment of an apparatus for adjusting steam pressure in the system for drying coal using reheat steam according to the present invention will be described with reference to FIGS. 5 to 9.

In FIG. 5, the steam chamber 120 has a space part accommodating the reheat steam therein. The steam supply pipe 121 supplying the high-temperature reheat steam generated by the reheater 500 is connected to one side of the steam chamber 120. A first steam distribution perforated plate 10 in which a plurality of first steam injection holes 11 is formed to penetrate is coupled to an inner upper part of the steam chamber 120. Moreover, the first steam distribution perforated plate 10 in which the plurality of first steam injection holes 11 is formed to penetrate is coupled to the top of the steam chamber 120.

The steam chamber 120 is installed below the transfer plate with the plurality of through-holes to inject the reheat steam at uniform pressure through the first steam injection holes 11.

A perforation ratio of the first steam injection holes 11 to an entire area of the first steam distribution perforated plate 10 may be approximately 10 to 15%.

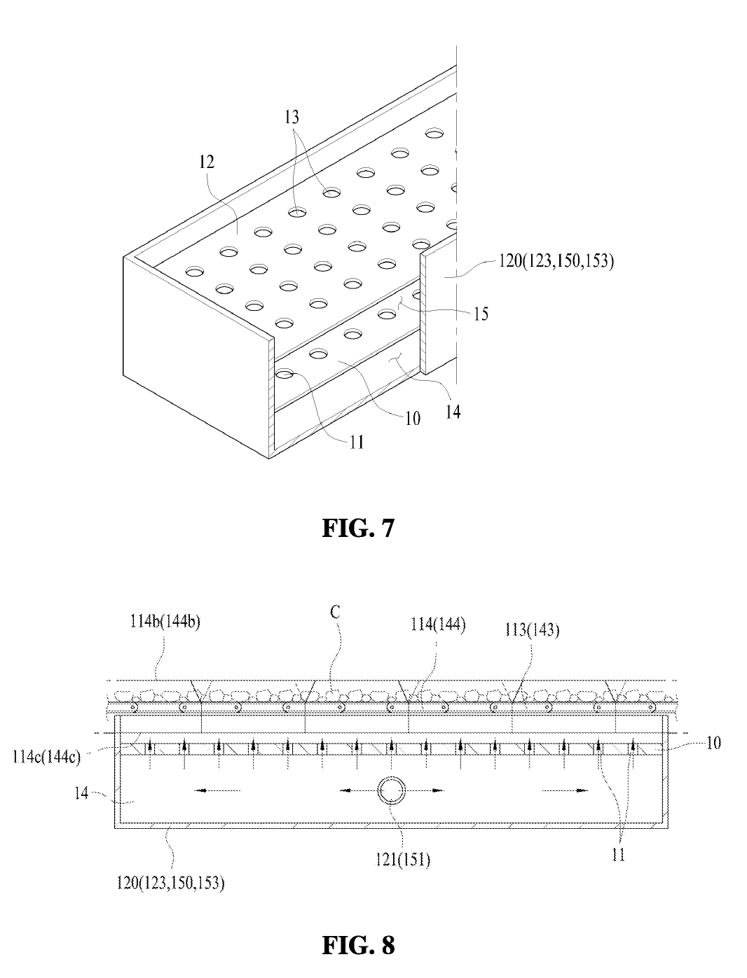

In FIG. 6, a coal pile to be dried is transferred onto the plurality of transfer plates 114 and 144 hinge-coupled to the respective chains 113 and 143, the steam chambers 120, 123, 150, and 153 are installed below the transfer plates 114 and 144, and the high-temperature reheat steam is supplied to the steam chamber through the steam supply pipes 121 and 151. In this case, the reheat steam supplied to each steam chamber is filled in an inner first space part 14 and thereafter, injected at uniform pressure through the first steam injection holes 11 formed in the first steam distribution perforated plate 10 formed at a predetermined interval. Accordingly, the reheat steam injected through the first steam injection holes 11 is applied to coal (C) particles through the through-holes 114a and 144a formed on the transfer plates 114 and 144. Therefore, while the high-temperature reheat steam passes through the porosity between the surface of the coal C and the coal, the moisture contained in the coal C is evaporated. Moreover, since the first steam injection holes 11 of the first steam distribution perforated plate 10 are arranged constantly, the reheat steam at uniform pressure is injected through the first steam injection holes 11 and the reheat steam at uniform pressure passes throughout the coal C on the transfer plates 114 and 144 to enhance a drying effect.

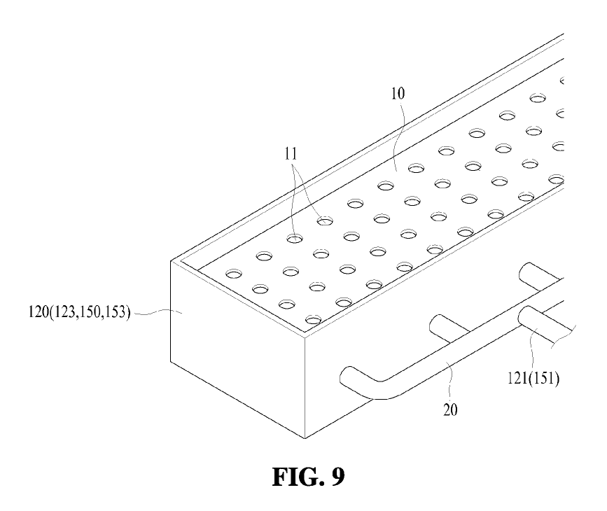

Further, in FIG. 7, as another embodiment of the steam chamber of the present invention, a second steam distribution perforated plate 12 where a plurality of second steam injection holes 13 is formed to penetrate is installed on the top of the first steam distribution perforated plate 10 installed in the first steam chamber 120 to the fourth steam chamber 153. The second steam distribution perforated plate 12 may be installed on the top of the first steam distribution perforated plate 10 and one or more second steam distribution perforated plates 12 may be installed.

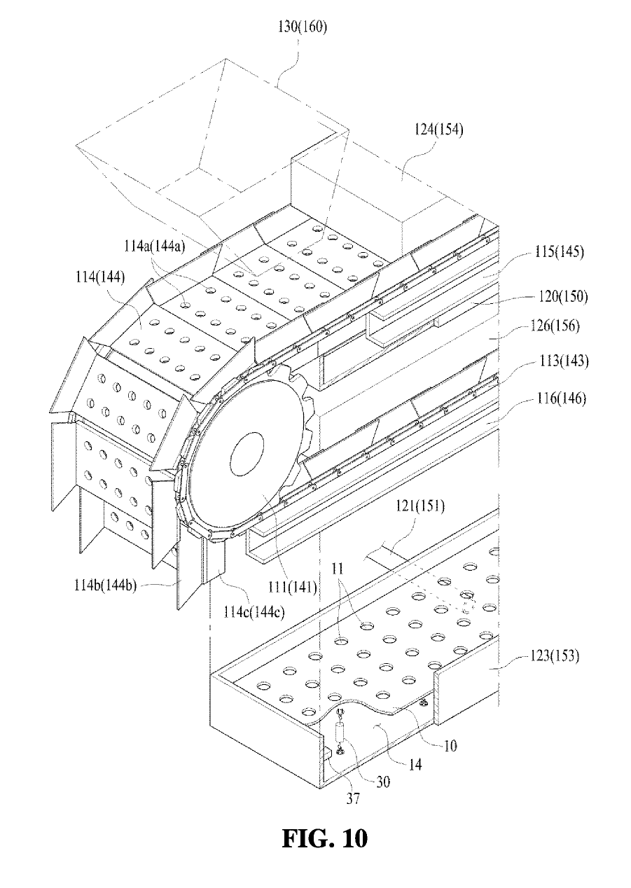

In FIG. 8, the high-temperature reheat steam supplied through the steam supply pipes 121 and 151 is filled in the inner first space part 14 of each of the first steam chamber 120 to the fourth steam chamber 153 and thereafter, the reheat is injected to a second space part 15 between the first steam distribution perforated plate 10 and the second steam distribution perforated plate 12 at uniform pressure through the first steam injection holes 11 formed in the first steam distribution perforated plate 10 at a predetermined interval. Further, the reheat steam filled in the second space part 15 is injected through the second steam injection holes 13 formed in the second steam distribution perforated plate 12. Accordingly, when the reheat steam is supplied to the first space part 14 of each of the first steam chamber 120 to the fourth steam chamber 153 from each of the steam supply pipes 121 and 151, the pressure of the reheat steam is primarily distributed by the first space part 14, and as a result, uniform pressure is maintained. In addition, the reheat steam filled in the first space part 14 is injected to the second space part 15 through the first steam injection holes 11 of the first steam distribution perforated plate 10 and thereafter, the pressure of the reheat steam is secondarily distributed by the second space part 15 to maintain uniform pressure.

Accordingly, the reheat steam filled the second space part 15 is injected to the coal (C) particles through the through-holes 114a and 144a formed on the transfer plates 114 and 144 through the second steam injection holes 13. Therefore, while the high-temperature reheat steam passes through the porosity between the surface of the coal C and the coal, the moisture contained in the coal C is evaporated. Moreover, since the second steam injection holes 13 of the second steam distribution perforated plate 12 are arranged constantly, the reheat steam at uniform pressure is injected through the second steam injection holes 13 and the reheat steam at more uniform pressure passes throughout the coal C on the transfer plates 114 and 144 to enhance the drying effect.

Further, the perforation ratio of the second steam injection holes 13 to the entire area of the second steam distribution perforated plate 12 may be 10 to 15%.

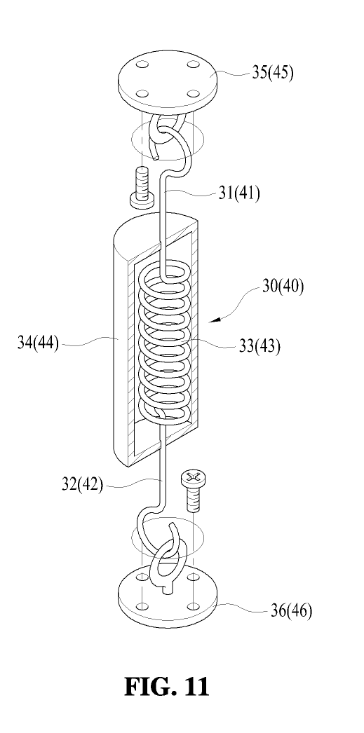

Meanwhile, in FIG. 9, as yet another embodiment of the present invention, a plurality of distribution steam supply pipes 20 is connected to one side of the steam chamber. That is, the distribution steam supply pipe 20 is connected to one side of each of the first steam chamber 120 to the fourth steam chamber 153, and as a result, the reheat steam at uniform pressure is filled in each first space part 14. Accordingly, the reheat steam at more uniform pressure is supplied and filled into each of the first steam chamber 120 to the fourth steam chamber 153 by the reheat steam branched and supplied to the distribution steam supply pipe 20, and as a result, the reheat steam at constant pressure is injected throughout the coal on the transfer plate.

A second embodiment of an apparatus for adjusting steam pressure in the system for drying coal using reheat steam according to the present invention will be described with reference to FIGS. 10 to 13.

In FIG. 10, the steam chamber 120 has a space part accommodating the reheat steam therein. The steam supply pipe 121 supplying the high-temperature reheat steam generated by the reheater 500 is connected to one side of the steam chamber 120. The first steam distribution perforated plate 10 in which the plurality of first steam injection holes 11 is formed to penetrate is installed in the inner upper part of the steam chamber 120. Moreover, the first steam distribution perforated plate 10 in which the plurality of first steam injection holes 11 is formed to penetrate may be coupled to the top of the steam chamber 120.

The steam chamber 120 is installed below the transfer plate with the plurality of through-holes to inject the reheat steam at uniform pressure through the first steam injection holes 11.

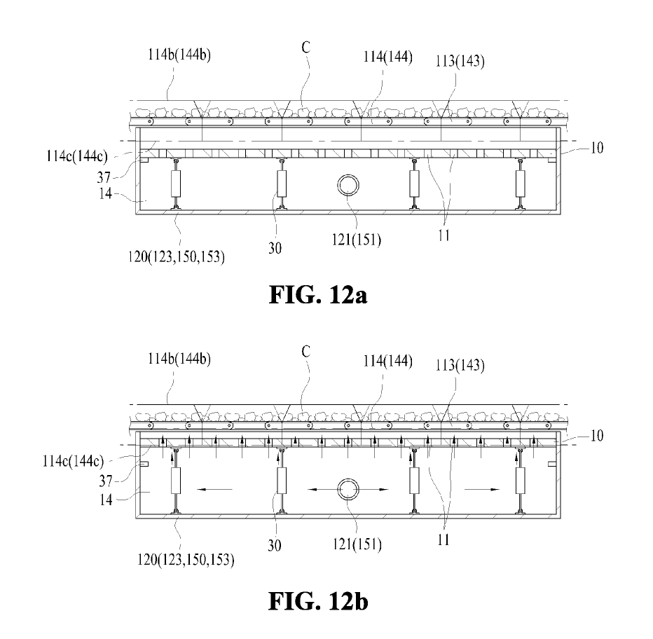

In FIG. 11, a first support member 31 is fixed to a first fixation member 35 provided on the bottom of the first steam distribution perforated plate 10 installed inside the steam chamber 120 and a second support member 32 is fixed to a second fixation member 36 provided on the bottom inside the steam chamber 120. A plurality of elastic supports 30 to which an elastic body 33 having elastic force having a predetermined magnitude is coupled is installed between the first support member 31 and the second support member 32. The first elastic support 30 is installed to support the first steam distribution perforated plate 10 to form the first space part 14 with the steam chamber 120 and the first steam distribution perforated plate 10 is lifted with steam pressure which flows in the first space part 14 to constantly maintain reheat steam injection pressure through the first steam injection holes 11.

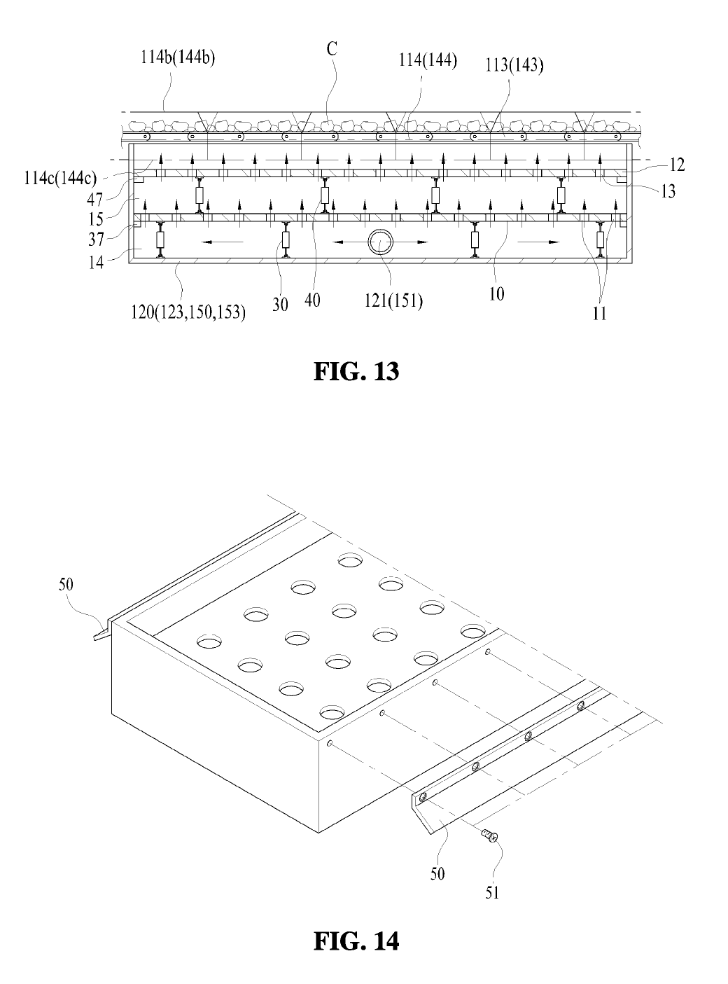

In FIG. 12a, when steam pressure flows into the first space part 14 of the steam chamber 120, the first steam distribution perforated plate 10 maintains a predetermined interval with the bottom surface of the steam chamber 120 by the elastic force of the elastic body 33. However, when the steam pressure flows into the first space part 14 of the steam chamber 120, while the first steam distribution perforated plate 10 is lifted by the steam pressure, uniform steam pressure is formed in the first space part 14. Accordingly, the uniform steam pressure formed in the first space part 14 is injected to the transfer plate through the first steam injection holes 11. Further, when the steam pressure does not flow into the steam chamber 120, the first steam distribution perforated plate 10 returns to an original location by the elastic force of the elastic body 33. As the elastic body 33, a tension spring is preferably adopted, but a compression spring may be adopted. In addition, a plurality of first elastic supports 30 are installed between the bottom surface of the steam chamber 120 and the first steam distribution perforated plate 10 at a predetermined interval, and as a result, the first elastic supports 30 preferably has elastic force to uniformly support the first steam distribution perforated plate 10 from the bottom surface of the steam chamber 120. A pocket 30 is coupled to the outer periphery of the first elastic support 30 to preferably prevent foreign materials from being fixed to the elastic body outside.

Further, a first stopper 37 for horizontally supporting the first steam distribution perforated plate 10 is installed on the inner wall of the steam chamber 120 to protrude. The first stopper 37 is configured to horizontally support the edge of the first steam distribution perforated plate 10 when the steam pressure is not generated in the first space part 14.

Moreover, in FIG. 12b, the coal C to be dried is transferred onto the plurality of transfer plates 114 and 144 hinge-coupled to the respective chains 113 and 143, the steam chambers 120, 123, 150, and 153 are installed below the transfer plates 114 and 144, and the high-temperature reheat steam is supplied to the steam chamber through the steam supply pipes 121 and 151. The reheat steam supplied to each steam chamber is filled in the first space part 14 and thereafter, predetermined pressure is formed and the first steam distribution perforated plate 10 is lifted by the pressure. In this case, primary pressure of the reheat steam itself which flows into the first space part 14 by the first steam distribution perforated plate 10 and secondary pressure by the first steam distribution perforated plate 10 are formed. The first steam distribution perforated plate 10 is lifted up to a predetermined height by elasticity of the plurality of first elastic supports 30 coupled to the bottom surface of the steam chamber. In addition, the reheat steam which maintains the predetermined pressure in the first space part 14 is injected at the uniform pressure through the first steam injection holes 11 formed in the first steam distribution perforated plate 10 formed at a predetermined interval.

Accordingly, the reheat steam injected through the first steam injection holes 11 is applied to each particle of the coal (C) through the through-holes 114a and 144a formed on the transfer plates 114 and 144. Therefore, while the high-temperature reheat steam passes through the porosity between the surface of the coal and the coal particles, the moisture contained in the coal particle is evaporated. Moreover, since the first steam injection holes 11 of the first steam distribution perforated plate 10 are arranged constantly, the reheat steam at uniform pressure is injected through the first steam injection holes 11 and the reheat steam at uniform pressure passes throughout the coal C on the transfer plates 114 and 144 to enhance the drying effect. Further, the plurality of elastic supports 30 elastically supports the first steam distribution perforated plate 10 to inject the steam pressure at more uniform steam pressure.

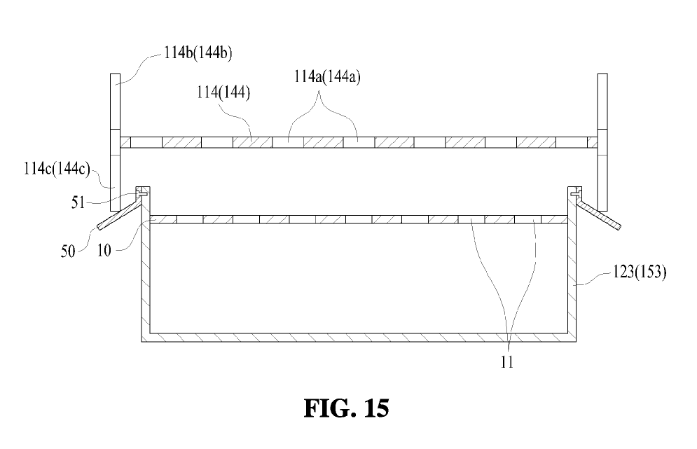

Further, in FIG. 13, as another embodiment of the steam chamber of the present invention, the second steam distribution perforated plate 12 where a plurality of second steam injection holes 13 is formed to penetrate is installed on the top of the first steam distribution perforated plate 10 installed in the first steam chamber 120 to the fourth steam chamber 153.

In addition, a first support member 42 is fixed to a third fixation member 46 provided on the bottom of the second steam distribution perforated plate 10 and a second support member 42 is fixed to a fourth fixation member 46 provided on the surface of the first steam distribution perforated plate 10. A plurality of second elastic supports 40 to which an elastic body 43 having elastic force having a predetermined magnitude is coupled is installed between the first support member 41 and the second support member 42. A plurality of second elastic supports 40 is installed to support the second steam distribution perforated plate 12. In addition, the second space part 15 is formed between the second steam distribution perforated plate 12 and the first steam distribution perforated plate 10. While the second steam distribution perforated plate 12 is lifted by the steam pressure which flows into the second space part 15, the injection pressure of the reheat steam is constantly maintained through the second steam injection holes 13. A pocket 44 is coupled to the outer periphery of the second elastic support 40 to preferably prevent the foreign materials from being fixed to the outside.

Further, the first stopper 37 for horizontally supporting the first steam distribution perforated plate 10 is installed on the inner wall of the steam chamber 120 to protrude and a second stopper 47 for horizontally supporting the second steam distribution perforated plate 12 is installed to protrude. When the steam pressure is not generated in the first space part 14, the first stopper 37 may horizontally support the edge of the first steam distribution perforated plate 10 and when the steam pressure is not generated in the second space part 15, the second stopper 47 may horizontally support the edge of the second steam distribution perforated plate 12.

Accordingly, the coal C to be dried is transferred onto the plurality of transfer plates 114 and 144 hinge-coupled to the respective chains 113 and 143, the steam chambers 120, 123, 150, and 153 are installed below the transfer plates 114 and 144, and the high-temperature reheat steam is supplied to the steam chamber through the steam supply pipes 121 and 151. The reheat steam supplied to each steam chamber is filled in the first space part 14 and thereafter, predetermined pressure is formed and the first steam distribution perforated plate 10 is lifted by the pressure. In this case, primary pressure of the reheat steam itself which flows into the first space part 14 by the first steam distribution perforated plate 10 and secondary pressure by the first steam distribution perforated plate 10 are formed. The first steam distribution perforated plate 10 is lifted up to a predetermined height by elasticity of the plurality of first elastic supports 30 coupled to the bottom surface of the steam chamber. In addition, the reheat steam which maintains the predetermined pressure in the first space part 14 is injected at the uniform pressure through the first steam injection holes 11 formed in the first steam distribution perforated plate 10 formed at a predetermined interval.

Further, the reheat steam injected through the first steam injection holes 11 of the first steam distribution perforated plate 10 and thereafter, predetermined pressure is formed to lift the second steam distribution perforated plate 12 by the pressure. In this case, the primary pressure of the reheat steam itself which flows into the second space part 15 by the first steam distribution perforated plate 12 and the secondary pressure by the second steam distribution perforated plate 12 are formed. The second steam distribution perforated plate 10 is lifted up to a predetermined height by the elasticity of the plurality of second elastic supports 40 coupled to the surface of the first steam distribution perforated plate 10. In addition, the reheat steam which maintains the predetermined pressure in the second space part 15 is injected at the uniform pressure through the second steam injection holes 13 formed in the second steam distribution perforated plate 12 formed at a predetermined interval.

Accordingly, the reheat steam injected through the second steam injection holes 13 is applied to each particle of the coal (C) through the through-holes 114a and 144a formed on the transfer plates 114 and 144. Therefore, while the high-temperature reheat steam passes through the porosity between the surface of the coal and the coal particles, the moisture contained in the coal particle is evaporated. Moreover, since the second steam injection holes 13 of the second steam distribution perforated plate 12 are arranged constantly, the reheat steam at uniform pressure is injected through the second steam injection holes 13 and the reheat steam at uniform pressure passes throughout the coal C on the transfer plates 114 and 144 to enhance the drying effect. Further, the plurality of second elastic supports 40 elastically supports the second steam distribution perforated plate 12 to inject the steam pressure at more uniform steam pressure. The reheat steam at more constant pressure may pass throughout the coal C on the transfer plates 114 and 144 with the steam pressure uniformly distributed by the first steam distribution perforated plate 10 elastically supported by the first elastic support 30 installed in the first space part 14 of the steam chamber and the reheat steam pressure more uniformly distributed and injected by the second steam distribution perforated plate 12 elastically supported by the second elastic support 40 installed in the second space part 15 of the steam chamber to more effectively and rapidly dry the coal C.

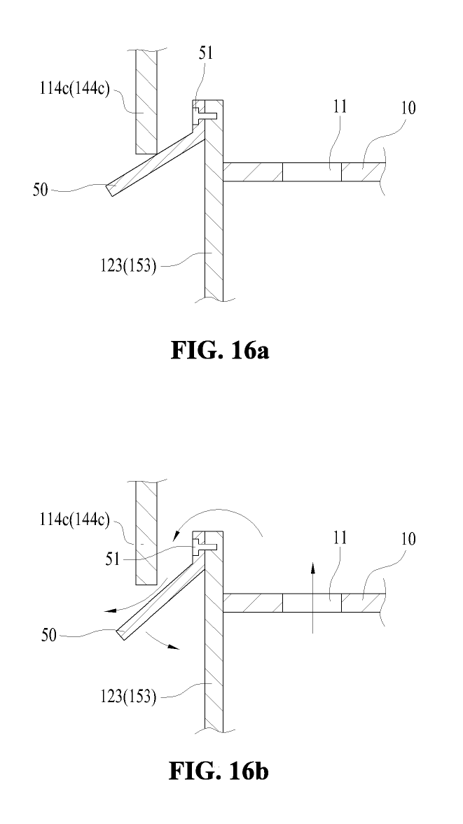

A third embodiment of an apparatus for adjusting steam pressure in the system for drying coal using reheat steam according to the present invention will be described with reference to FIGS. 14 to 20.

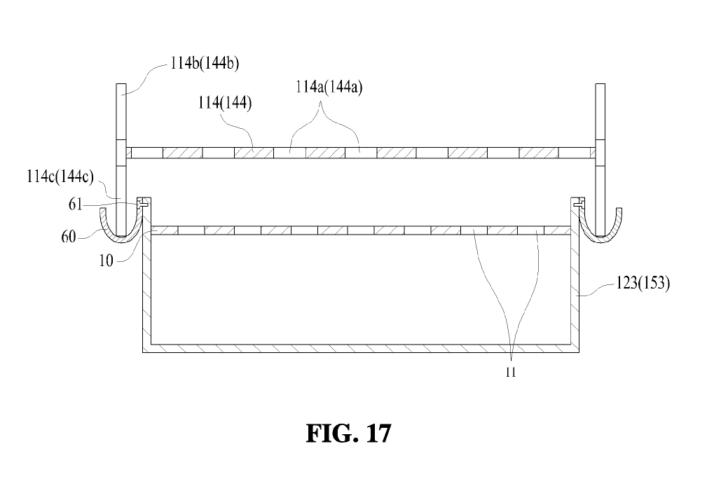

In FIGS. 14 and 15, the guards 114b and 144b are integrally coupled to left and right tops of the transfer plates 114 and 144, shield plates 114c and 144c are integrally coupled to left and right bottoms of the transfer plates 114 and 144, and one side of the first steam pressure adjuster 50 having the elasticity is fixedly installed on each of both side walls of the steam chamber 120 installed below the transfer plates 114 and 144 by the fixation member 51. The first steam pressure adjuster 50 is a leaf spring having an approximately flat plate shape.

Meanwhile, when the steam pressure injected into the transfer plates 114 and 144 from the steam chamber 120 is equal to or more than predetermined pressure, coal having small particles loaded and transferred on the transfer plates 114 and 144 is scattered to generate dust, and as a result, the steam pressure injected to the transfer plates 114 and 144 from the steam chamber 120 needs to be adjusted.

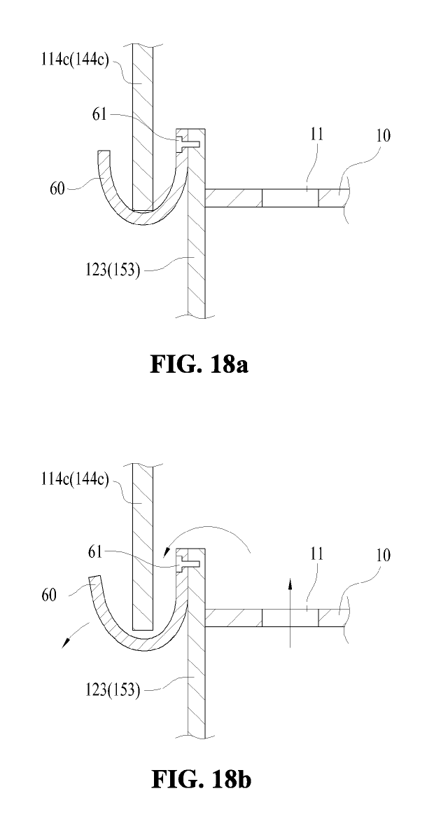

Accordingly, in FIG. 16a, when the steam pressure of the reheat steam transferred from the steam chamber 120 is equal to or more tan the predetermined pressure while the surface of the first steam pressure adjuster 50 contact the bottoms of the shield plates 114c and 144c, the steam pressure presses the first steam pressure adjuster 50 having the elasticity to discharge the reheat steam between the first steam pressure adjuster 50 and the shield plates 114c and 144c, thereby adjusting the steam pressure at predetermined pressure or more.

In FIG. 16b, the coal C to be dried is transferred onto the plurality of transfer plates 114 and 144 hinge-coupled to the respective chains 113 and 143, the steam chambers 120, 123, 150, and 153 are installed below the transfer plates 114 and 144, and the high-temperature reheat steam is supplied to the steam chamber through the steam supply pipes 121 and 151. The reheat steam supplied to each steam chamber is filled in the first space part 14 and thereafter, predetermined pressure is formed and the steam distribution perforated plate 10 is lifted by the pressure. In this case, the primary pressure of the reheat steam itself which flows into the first space part 14 by the steam distribution perforated plate 10 and the secondary pressure by the steam distribution perforated plate 10 are formed.

Accordingly, the reheat steam injected through the steam injection holes 11 is applied to each particle of the coal (C) through the through-holes 114a and 144a formed on the transfer plates 114 and 144. Therefore, while the high-temperature reheat steam passes through the porosity between the surface of the coal and the coal particles, the moisture contained in the coal particle is evaporated. Moreover, since the steam injection holes 11 of the steam distribution perforated plate 10 are arranged constantly, the reheat steam at uniform pressure is injected through the steam injection holes 11 and the reheat steam at uniform pressure passes throughout the coal C on the transfer plates 114 and 144 to enhance the drying effect. In this case, when the reheat steam at predetermined pressure is injected from the steam chamber 120, the steam pressure increases between the transfer plates 114 and 144 and the steam distribution perforated plate 10 of the steam chamber 120 and the steam pressure is dispersed to the left and right sides of the steam chamber 120. The first steam pressure adjuster 50 fixedly to the side wall of the steam chamber 120 and contacting the shield plates 114c and 144c is pushed down by the steam pressure dispersed by the steam chamber 120 to generate a gap interval with the shield plates 114c and 144c. Since the reheat steam is discharged through the gap interval generated between the first steam pressure adjuster 50 and the shield plates 114c and 144c by the steam pressure, the steam pressure between the transfer plates 114 and 144 and the steam chamber 120 decreases, and as a result, the pressure of the reheat steam injected to the transfer plates 114 and 144 also decreases. Further, when the steam pressure between the transfer plates 114 and 144 and the steam chamber 120 decreases, the first steam pressure adjuster 50 returns to the bottoms of the shield plates 114c and 144c by the elasticity to interrupt the discharged reheat steam. The first steam pressure adjuster 50 has a characteristic such as an approximately leaf spring and as the elastic force of the first steam pressure adjuster 50, it is adopted that a balance of mutual forces of the steam pressures formed between the transfer plates 114 and 144 and the steam chamber 120 is appropriately formed. That is, when the steam pressure formed between the transfer plates 114 and 144 and the steam chamber 120 is equal to or more than set steam pressure, that is, steam pressure at which the coal particles are scattered to generate the dust, the elastic force to separate the first steam pressure adjuster 50 from the shield plates 114c and 144c is preferably provided to the first steam pressure adjuster 50.

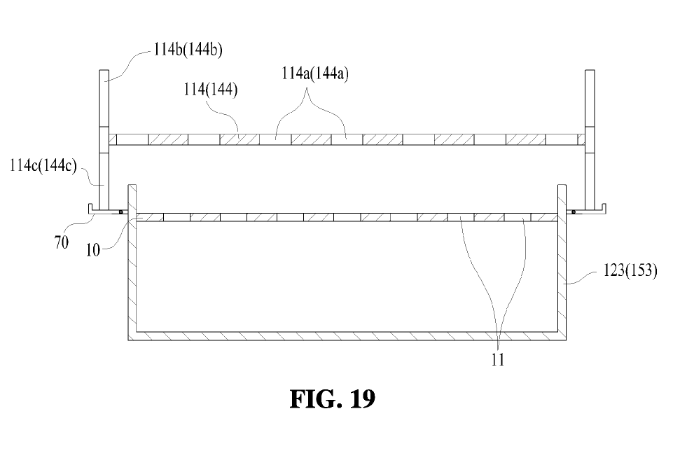

Further, in FIG. 17, as another example of the present invention, in the apparatus for adjusting steam pressure of the reheat steam supply chamber, the guards 114b and 144b are integrally coupled to the left and right tops of the transfer plates 114 and 144, the shield plates 114c and 144c are integrally coupled to the left and right bottoms of the transfer plates 114 and 144, and one side of the second steam pressure adjuster 60 having the elasticity is fixedly installed on each of both side walls of the steam chamber 120 installed below the transfer plates 114 and 144 by the fixation member 61. The second steam pressure adjuster 60 has the elasticity in a substantially U shape.

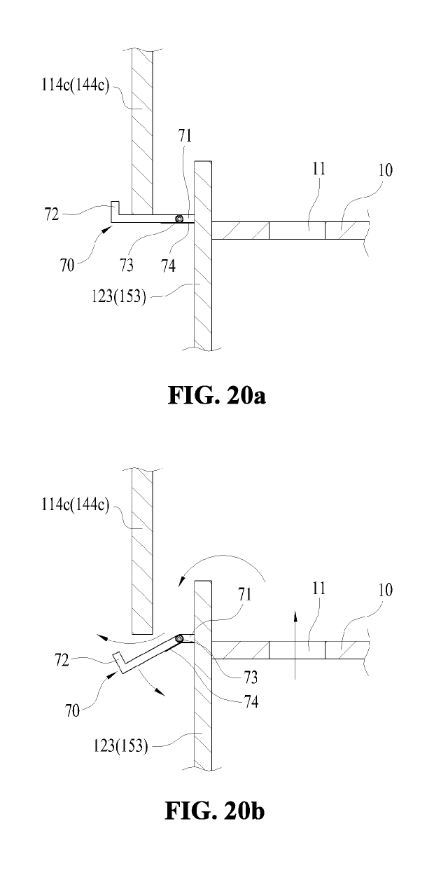

Accordingly, in FIG. 18a, when the steam pressure of the reheat steam transferred from the steam chamber 120 is equal to or more tan the predetermined pressure while the inner surface of the second steam pressure adjuster 60 contact the bottoms of the shield plates 114c and 144c, the steam pressure presses the second steam pressure adjuster 60 having the elasticity to discharge the reheat steam between the second steam pressure adjuster 60 and the shield plates 114c and 144c, thereby adjusting the steam pressure at predetermined pressure or more.

In FIG. 18b, when the reheat steam at predetermined pressure is injected from the steam chamber 120, the steam pressure increases between the transfer plates 114 and 144 and the steam distribution perforated plate 10 of the steam chamber 120 and the steam pressure is dispersed to the left and right sides of the steam chamber 120. The second steam pressure adjuster 60 fixedly to the side wall of the steam chamber 120 and contacting the shield plates 114c and 144c is pushed down by the steam pressure dispersed by the steam chamber 120 to generate the gap interval with the shield plates 114c and 144c. Since the reheat steam is discharged through the gap interval generated between the second steam pressure adjuster 60 and the shield plates 114c and 144c by the steam pressure, the steam pressure between the transfer plates 114 and 144 and the steam chamber 120 decreases, and as a result, the pressure of the reheat steam injected to the transfer plates 114 and 144 also decreases. Further, when the steam pressure between the transfer plates 114 and 144 and the steam chamber 120 decreases, the second steam pressure adjuster 60 returns to the bottoms of the shield plates 114c and 144c by the elasticity to interrupt the discharged reheat steam. The second steam pressure adjuster 60 has the U shape having the elasticity and as the elastic force of the second steam pressure adjuster 60, it is adopted that the balance of the mutual forces of the steam pressures formed between the transfer plates 114 and 144 and the steam chamber 120 is preferably appropriately formed. That is, when the steam pressure formed between the transfer plates 114 and 144 and the steam chamber 120 is equal to or more than the set steam pressure, that is, the steam pressure at which the coal particles are scattered to generate the dust, the elastic force to separate the second steam pressure adjuster 60 from the shield plates 114c and 144c is preferably provided to the second steam pressure adjuster 60.

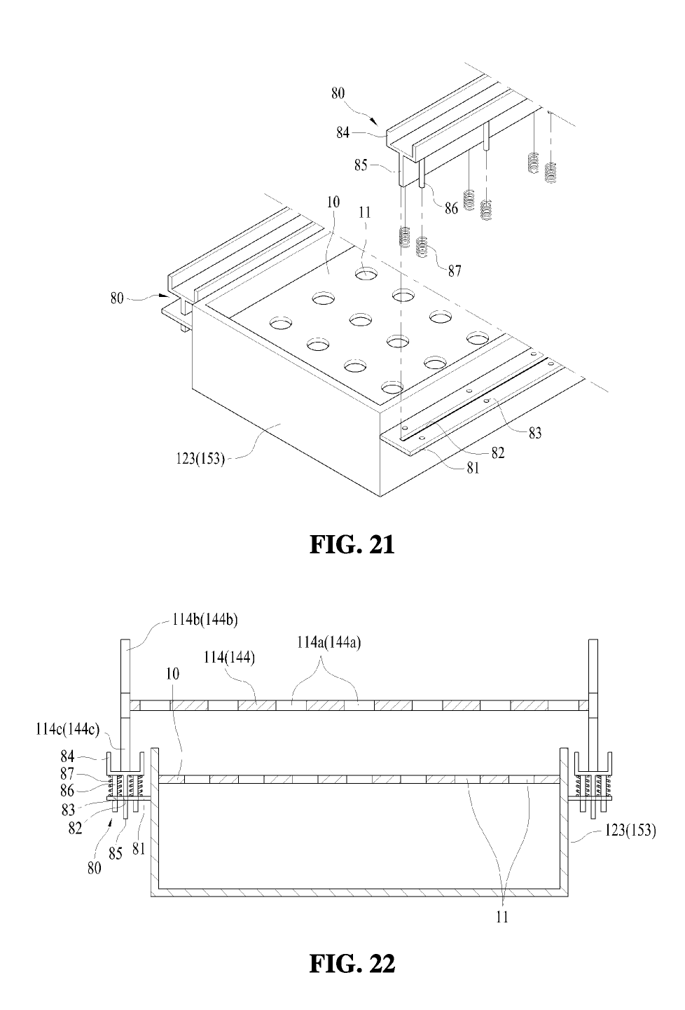

Further, in FIG. 19, as another example of the present invention, in the apparatus for adjusting steam pressure of the reheat steam supply chamber, the guards 114b and 144b are integrally coupled to the left and right tops of the transfer plates 114 and 144, the shield plates 114c and 144c are integrally coupled to the left and right bottoms of the transfer plates 114 and 144, and one side of a third steam pressure adjuster 70 having the elasticity is fixedly installed on each of both side walls of the steam chamber 120 installed below the transfer plates 114 and 144.

The third steam pressure adjuster 70 has the elasticity in a substantially “L” shape. Moreover, in the third steam pressure adjuster 70, a fixation plate 71 and an operation plate 72 are coupled to each other by a hinge 73. One side of the fixation plate 71 is fixed onto the side wall of the steam chamber 120 and the other side of the fixation plate 71 is coupled with the hinge 73. The fixation plate 71 has a substantially flat plate shape. The bottoms of the shield plates 114c and 144c contact the surface of the operation plate 72 in the substantially “ [symbol] ” shape. One side of the operation plate 72 is coupled to the hinge 73. Moreover, the fixation plate 71 and the operation plate 72 coupled to the hinge 73 are elastically supported by a spring.

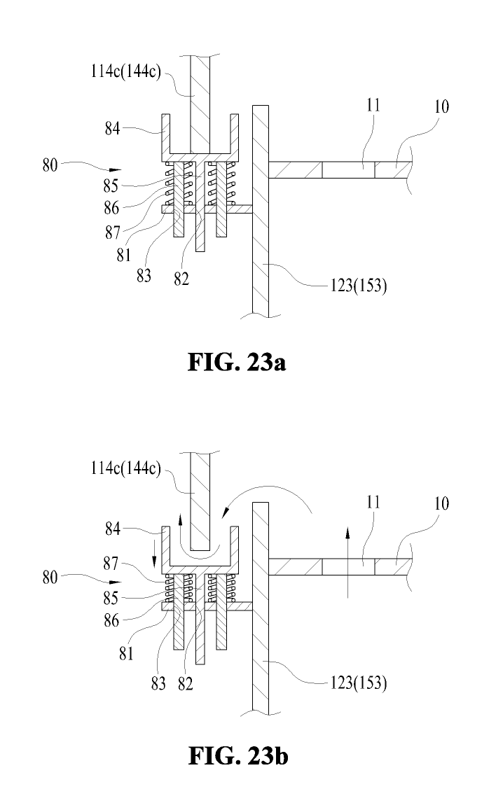

Accordingly, in FIG. 20a, when the steam pressure of the reheat steam transferred from the steam chamber 120 is equal to or more tan the predetermined pressure while the surface of the operation plate 72 of the third steam pressure adjuster 70 contact the bottoms of the shield plates 114c and 144c, the steam pressure presses the third steam pressure adjuster 70 to discharge the reheat steam between the third steam pressure adjuster 70 and the shield plates 114c and 144c, thereby adjusting the steam pressure at predetermined pressure or more.

In FIG. 20b, when the reheat steam at predetermined pressure is injected from the steam chamber 120, the steam pressure increases between the transfer plates 114 and 144 and the steam distribution perforated plate 10 of the steam chamber 120 and the steam pressure is dispersed to the left and right sides of the steam chamber 120. In the third steam pressure adjuster 70 in which the operation plate 72 is fixed to the side wall of the steam chamber 120 and the operation plate 72 coupled with the fixation plate 71 through the hinge 73 contacts the shield plates 114c and 144c, the operation plate 72 is pushed down by the steam pressure dispersed by the steam chamber 120 to generate the gap interval with the shield plates 114c and 144c. Since the reheat steam is discharged through the gap interval generated between the operation plate 72 of the third steam pressure adjuster 70 and the shield plates 114c and 144c by the steam pressure, the steam pressure between the transfer plates 114 and 144 and the steam chamber 120 decreases, and as a result, the pressure of the reheat steam injected to the transfer plates 114 and 144 also decreases. Further, when the steam pressure between the transfer plates 114 and 144 and the steam chamber 120 decreases, the operation plate 72 of the third steam pressure adjuster 70 returns to the bottoms of the shield plates 114c and 144c by the elasticity to interrupt the discharged reheat steam. The operation plate 72 of the third steam pressure adjuster 70 has the “ [symbol] ” shape having the elasticity and as the elastic force of a spring 74 coupled between the operation plate 72 of the third steam pressure adjuster 70 and the fixation plate 71, it is adopted that the balance of the mutual forces of the steam pressures formed between the transfer plates 114 and 144 and the steam chamber 120 is preferably appropriately formed. That is, when the steam pressure formed between the transfer plates 114 and 144 and the steam chamber 120 is equal to or more than the set steam pressure, that is, the steam pressure at which the coal particles are scattered to generate the dust, the elastic force to separate the spring 74 coupled with the operation plate 72 of the third steam pressure adjuster 70 from the shield plates 114c and 144c is preferably provided to the spring 74.

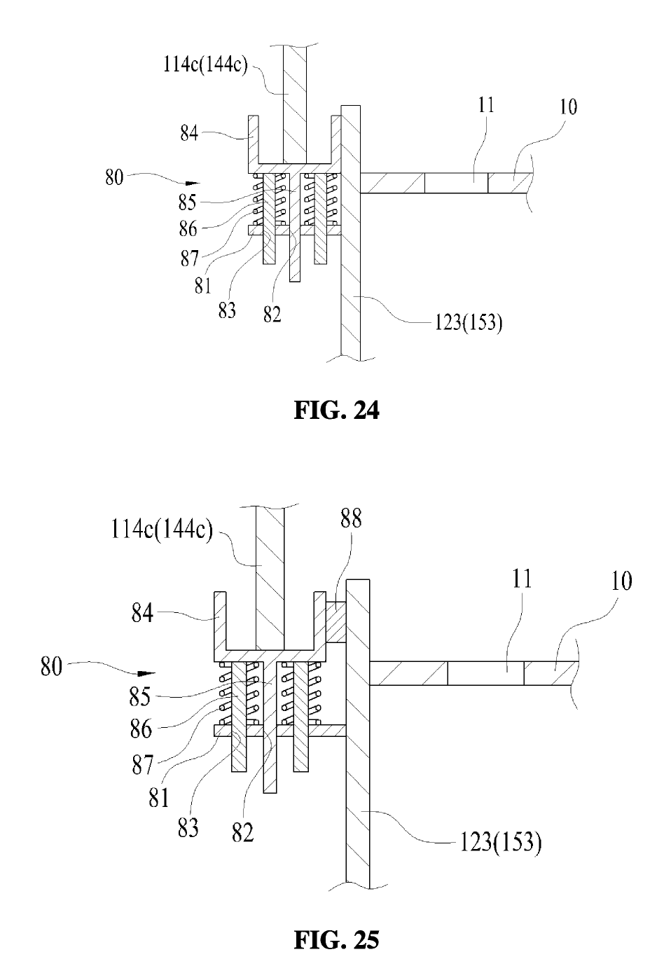

A fourth embodiment of an apparatus for adjusting steam pressure in the system for drying coal using reheat steam according to the present invention will be described with reference to FIGS. 21 to 25.

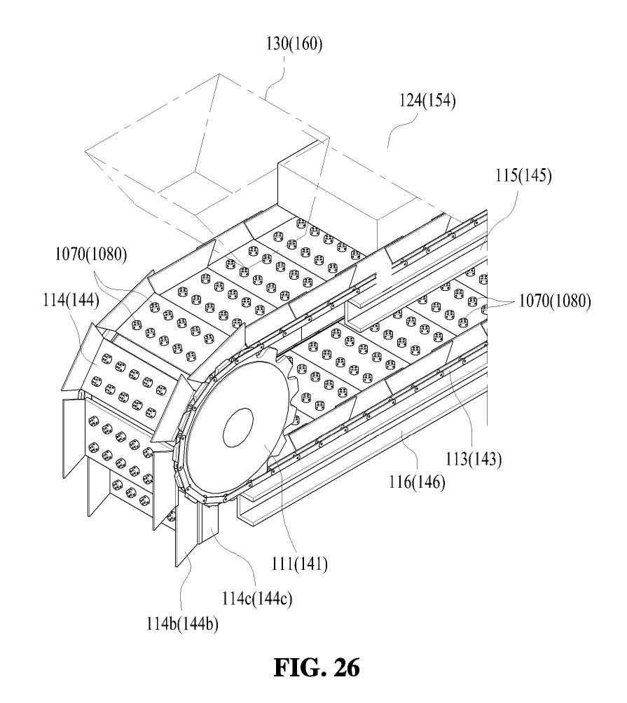

In FIGS. 21 and 22, the guards 114b and 144b are integrally coupled to the left and right tops of the transfer plates 114 and 144, the shield plates 114c and 144c are integrally coupled to the left and right bottoms of the transfer plates 114 and 144, and one side of a steam pressure adjuster 80 having the elasticity is fixedly installed on each of both plates of the steam chamber 120 installed below the transfer plates 114 and 144 by the fixation member 51.

Moreover, in the steam pressure adjuster 80, a guide plate 81 is installed on each of both side walls of the steam chamber 120 installed below the transfer plates 114 and 144. A long hole 82 is formed at the center of the guide plate 81 in the longitudinal direction, that is, in a direction parallel to the side wall of the steam chamber 120. A plurality of through-holes 83 are formed at both sides of the long hole 82 at a predetermined interval. The guide plate 81 having the substantially flat plate shape may be fixed to both side walls of the steam chamber 120 and fixed by using the fixation member.

An operation member 84 is installed above the guide plate 81. The operation member 84 is installed to contact the bottoms of the shield plates 114c and 144c above the guide plate 81. The operation member 84 has a substantially “ E ” shape and the shield plates 114c and 144c contact the inner bottom surface at a groove portion.

An elevation plate 85 has a plate shape which is formed to protrude downward on the bottom of the operation member 84. The elevation plate 85 is elevated while being inserted into the long hole 82 formed on the guide plate 81. A plurality of guide rods 86 are coupled to both sides of the elevation plate 85. The guide rods 86 having a rod shape which is formed to protrude downward on the bottom of the operation member 84 are elevated while being inserted into the through-holes 83 formed on the guide plate 81, respectively. In addition, the guide rods 86 are elastically supported by a spring 87 between the bottom of the operation member 84 and the surface of the guide plate 81.

Meanwhile, when the steam pressure injected into the transfer plates 114 and 144 from the steam chamber 120 is equal to or more than predetermined pressure, coal having small particles loaded and transferred on the transfer plates 114 and 144 is scattered to generate dust, and as a result, the steam pressure injected to the transfer plates 114 and 144 from the steam chamber 120 needs to be adjusted.

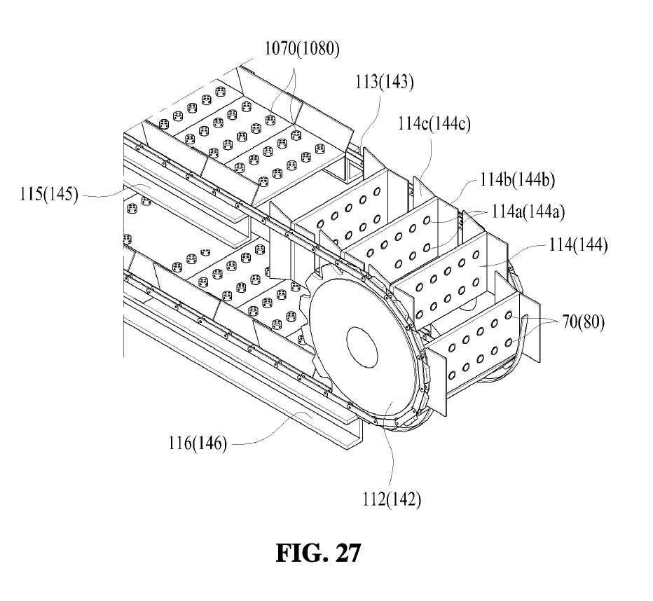

Accordingly, in FIG. 23a, when the steam pressure of the reheat steam transferred from the steam chamber 120 is equal to or more tan the predetermined pressure while the inner surface of the operation member 84 of the steam pressure adjuster 80 contacts the shield plates 114c and 144c, the steam pressure presses the spring 87 elastically supported on the guide rod 86 on the bottom of the operation member 84 to discharge the reheat steam between the operation member 84 of the steam pressure adjuster 80 and the shield plates 114c and 144c, thereby adjusting the steam pressure at predetermined pressure or more.

In FIG. 23b, the coal C to be dried is transferred onto the plurality of transfer plates 114 and 144 hinge-coupled to the respective chains 113 and 143, the steam chambers 120, 123, 150, and 153 are installed below the transfer plates 114 and 144, and the high-temperature reheat steam is supplied to the steam chamber through the steam supply pipes 121 and 151. The reheat steam supplied to each steam chamber is filled in the first space part 14 and thereafter, predetermined pressure is formed and the steam distribution perforated plate 10 is lifted by the pressure. In this case, the primary pressure of the reheat steam itself which flows into the first space part 14 by the steam distribution perforated plate 10 and the secondary pressure by the steam distribution perforated plate 10 are formed.

Accordingly, the reheat steam injected through the steam injection holes 11 is applied to each particle of the coal (C) through the through-holes 114a and 144a formed on the transfer plates 114 and 144. Therefore, while the high-temperature reheat steam passes through the porosity between the surface of the coal and the coal particles, the moisture contained in the coal particle is evaporated. Moreover, since the steam injection holes 11 of the steam distribution perforated plate 10 are arranged constantly, the reheat steam at uniform pressure is injected through the steam injection holes 11 and the reheat steam at uniform pressure passes throughout the coal C on the transfer plates 114 and 144 to enhance the drying effect.

In this case, when the reheat steam at predetermined pressure is injected from the steam chamber 120, the steam pressure increases between the transfer plates 114 and 144 and the steam distribution perforated plate 10 of the steam chamber 120 and the steam pressure is dispersed to the left and right sides of the steam chamber 120. The dispersed steam pressure presses the operation member 84 contacting the shield plates 114c and 144c and the operation member 84 pushes down the elevation plate 85 and the guide rod 86 inserted into the long hole 82 and the plurality of through-holes 83 formed on the guide plate 81, respectively. In this case, a gap is formed while the operation member 84 contacting the shield plates 114c and 144c moves down and the steam pressure of the steam chamber 120 is discharged through the gap. In addition, the elevation plate 85 has a function to interrupt the steam pressure generated by the steam chamber 120 from being discharged without permission.

Since the reheat steam is discharged through the gap interval generated between the operation member 84 of the steam pressure adjuster 84 and the shield plates 114c and 144c by the steam pressure of the steam chamber 120, the steam pressure between the transfer plates 114 and 144 and the steam chamber 120 decreases, and as a result, the pressure of the reheat steam injected to the transfer plates 114 and 144 also decreases. Further, when the steam pressure between the transfer plates 114 and 144 and the steam chamber 120 decreases up to the predetermined pressure or less, the operation plate 84 of the steam pressure adjuster 80 is lifted by the elastic force of the spring 87 elastically supported on the guide rod 86 and the gap is clogged between the shield plates 114c and 144c and the operation member 84 to prevent the reheat steam from being discharged.

As the elastic force of the spring 87 on the outer periphery of the guide rod 86 between the operation member 84 of the steam pressure adjuster 80 and the guide plate 81, it is adopted that the balance of the mutual forces of the steam pressures formed between the transfer plates 114 and 144 and the steam chamber 120 is appropriately formed. That is, when the steam pressure formed between the transfer plates 114 and 144 and the steam chamber 120 is equal to or more than the set steam pressure, that is, the steam pressure at which the coal particles are scattered to generate the dust, the elastic force to separate the operation member 84 from the shield plates 114c and 144c is preferably provided to the operation member 84 elastically supported by the spring 87 mounted on the outer periphery of the guide rod 86 of the steam pressure adjuster 80.

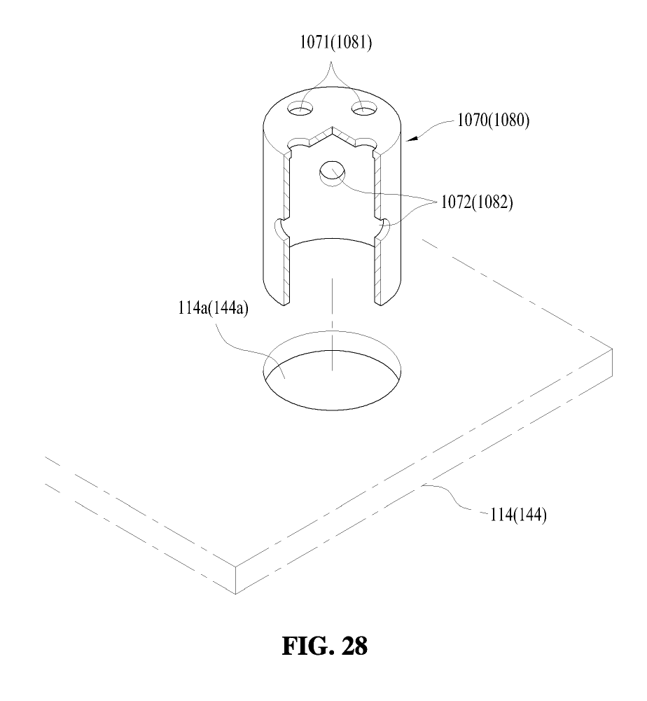

Further, as another example of the present invention, in FIG. 24, one surface of the operation member 84 is installed to contact the side wall of the steam chamber 120.

In this case, the total steam pressure of the reheat steam formed between the steam chamber 120 and the transfer plates 114 and 144 is transferred to the operation member 84 to more effectively adjust the steam pressure. Moreover, the operation member 84 operates more sensitively to the steam pressure to discharge or interrupt the steam pressure between the shield plates 114c and 144c and the operation member 84.

Further, as yet another example of the present invention, in FIG. 25, an interruption protrusion 88 is installed to protrude in a horizontal direction outside the side wall of the steam chamber 120 and the side of the operation member 84 is installed to contact the interruption protrusion 88.

In this case, the total steam pressure of the reheat steam formed between the steam chamber 120 and the transfer plates 114 and 144 is transferred to the operation member 84 to more effectively adjust the steam pressure. Moreover, the operation member 84 operates more sensitively to the steam pressure to discharge or interrupt the steam pressure between the shield plates 114c and 144c and the operation member 84. In addition, since the side of the operation member 84 contacts the interruption protrusion 88, the steam pressure of the steam chamber 120 is not almost lost, but is applied to the operation member 84 to prevent the coal particles transferred on the surface of the transfer plate from being scattered without permission by adjusting the steam pressure.

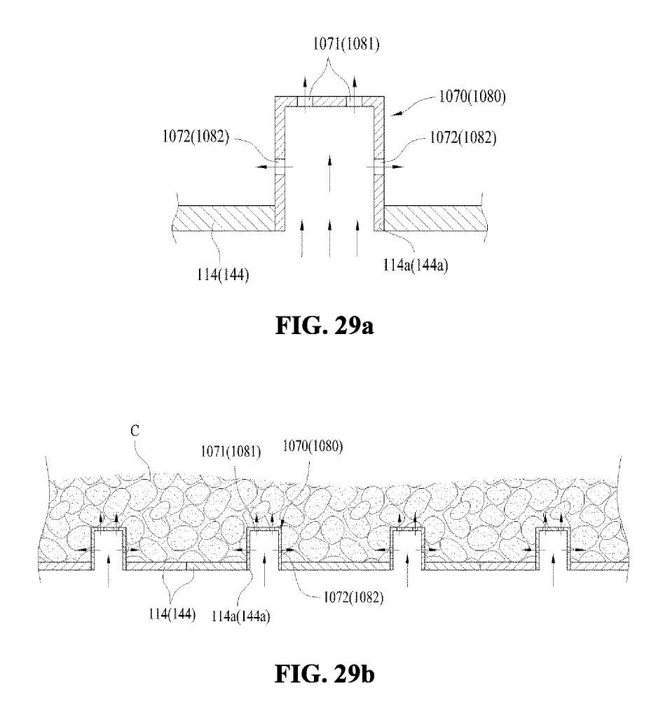

A fifth embodiment of an apparatus for adjusting steam pressure in the system for drying coal using reheat steam according to the present invention will be described with reference to FIGS. 26 to 30.

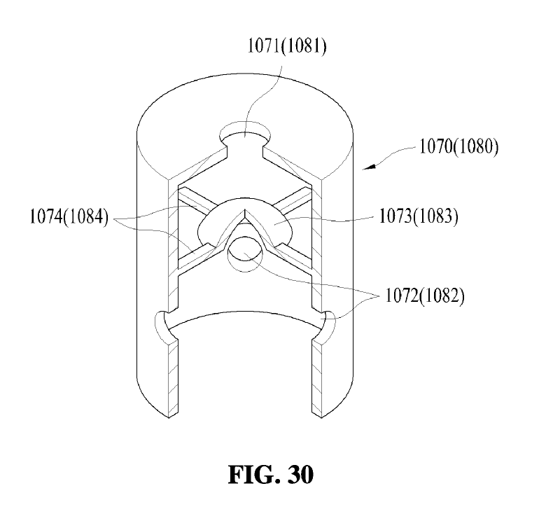

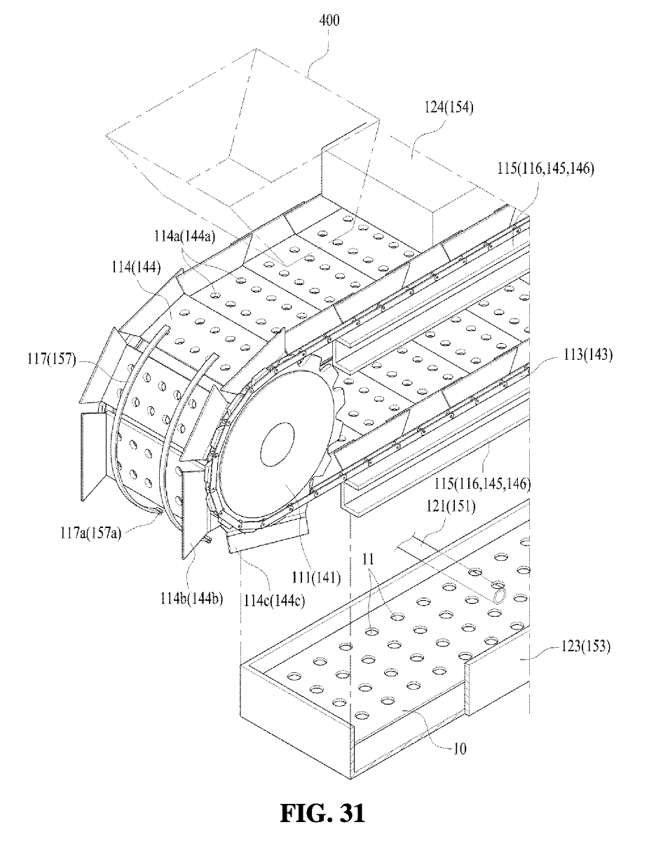

Meanwhile, in FIGS. 28 and 29a, a first injection cap 1070 is a cylindrical shape which is coupled to the through-hole 114a formed to penetrate on the first transfer plate 114 to protrude. One or more first injection holes 1071 are formed on the top of the first injection cap 1070 to penetrate and a plurality of second injection holes 1072 is formed on a cylindrical outer peripheral side of the first injection cap 1070 to penetrate. Moreover, the first transfer plate 114 to which the first injection cap 1070 is coupled is hinge-coupled to the first chain 113 connected between the first drive sprocket 111 and the first driven sprocket 112 of the first coal dryer 110. The first injection cap 1070 disperses and injects the reheat steam injected from the first steam chamber 120 below the transfer plate 114, that is, the upper first transfer plate 114 through a first injection hole 1071 and a second injection hole 1072 and disperses and injects the reheat steam injected from the second steam chamber 123 below the lower first transfer plate 114 through the first injection hole 1071 and the second injection hole 1072. The reheat steam is injected to the coal pile load and transferred on the surface of the transfer plate 114 with a predetermined thickness by penetrating from the bottom to the top through the first injection hole 1071 and injected to the inside of the side of the coal pile through the second injection hole 1072 to maximize coal drying efficiency.

Further, a second injection cap 1080 is a cylindrical shape which is coupled to the through-hole 144a formed to penetrate on the second transfer plate 144 to protrude. One or more first injection holes 1081 are formed on the top of the second injection cap 1080 to penetrate and a plurality of second injection holes 1082 is formed on the cylindrical outer peripheral side of the second injection cap 1080 to penetrate. Moreover, the second transfer plate 144 to which the second injection cap 1080 is coupled is hinge-coupled to the second chain 143 connected between the second drive sprocket 141 and the first driven sprocket 142 of the second coal dryer 140. The second injection cap 1080 disperses and injects the reheat steam injected from the third steam chamber 150 below the transfer plate 144, that is, the upper first transfer plate 144 through the first injection hole 1081 and the second injection hole 1082 and disperses and injects the reheat steam injected from the fourth steam chamber 153 below the lower second transfer plate 154 through the first injection hole 1081 and the second injection hole 1082. The reheat steam is injected to the coal pile load and transferred on the surface of the transfer plate 144 with a predetermined thickness by penetrating from the bottom to the top through the first injection hole 1081 and injected to the inside of the side of the coal pile through the second injection hole 1082 to maximize the coal drying efficiency.

In FIG. 29b, the height of the first injection cap 1070 formed on the first transfer plate 114 to protrude needs to be formed to be lower than the bottom of a first flattener 30 and is preferably formed to be lower than the loaded coal. Accordingly, the reheat steam injected from the first steam chamber 120 is dispersed and injected to the coal pile loaded and transferred onto the upper first transfer plate 114 in each of the first injection hole 1071 and the second injection hole 1072 of the first injection cap 1070. Therefore, the coal pile loaded and transferred onto the upper first transfer plate 114 is subjected to a drying process by the reheat steam injected from the top and the side from the first injection cap 1070 to enhance the drying efficiency to the inside of the coal pile C.

In addition, the coal pile which is subjected to the drying process by the reheat steam injected from the first injection cap 1070 of the upper first transfer plate 114 and thereafter, loaded on the upper first transfer plate 114 is dropped onto the surface of the lower first transfer plate 114. The reheat steam injected from the second steam chamber 123 is dispersed and injected to the coal pile loaded and transferred onto the lower first transfer plate 114 in each of the first injection hole 1071 and the second injection hole 1072 of the first injection cap 1070. The coal pile loaded on the lower first transfer plate 114 is subjected to the drying process by the reheat steam injected from the top and the side from the first injection cap 1070 while being transferred to enhance the drying efficiency to the inside of the coal pile C.

The height of the second injection cap 1080 formed on the second transfer plate 144 to protrude needs to be formed to be lower than the bottom of a third flattener 30 and is preferably formed to be lower than the loaded coal. Accordingly, the reheat steam injected from the third steam chamber 150 is dispersed and injected to the coal pile loaded and transferred onto the upper second transfer plate 144 in each of the first injection hole 1081 and the second injection hole 1082 of the second injection cap 1080. Therefore, the coal pile loaded and transferred onto the upper second transfer plate 144 is subjected to the drying process by the reheat steam injected from the top and the side from the second injection cap 1080 to enhance the drying efficiency to the inside of the coal pile C.

The reheat steam injected from the fourth steam chamber 153 is dispersed and injected to the coal pile loaded and transferred onto the lower second transfer plate 144 in each of the first injection hole 1081 and the second injection hole 1082 of the second injection cap 1080. The coal pile loaded on the lower second transfer plate 144 is subjected to the drying process by the reheat steam injected from the top and the side from the second injection cap 1080 while being transferred to enhance the drying efficiency to the inside of the coal pile C.

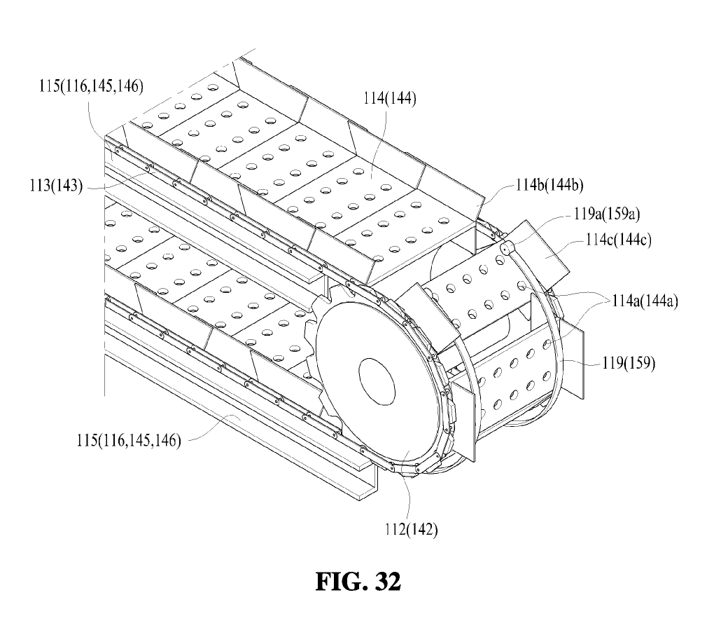

Meanwhile, in FIG. 30, as another example of the first injection cap 1070 and the second injection cap 1080, substantially semi-spherical pressure maintaining members are connected to and installed in a plurality of support pieces 1074, respectively in the injection cap. After the reheat steam injected from the corresponding steam chamber maintains predetermined pressure by the corresponding pressure maintaining members 1073 and 1083, the reheat steam is injected to the second injection holes 1072 and 1082 and the reheat steam discharged between the respective support pieces 1074 and 1084 are injected to the first injection holes 1071 and 1084, respectively again. Accordingly, the pressure maintaining member installed in each injection cap allows the reheat steam to be injected to the side at predetermined pressure to enhance the drying effect to the side of the coal pile.

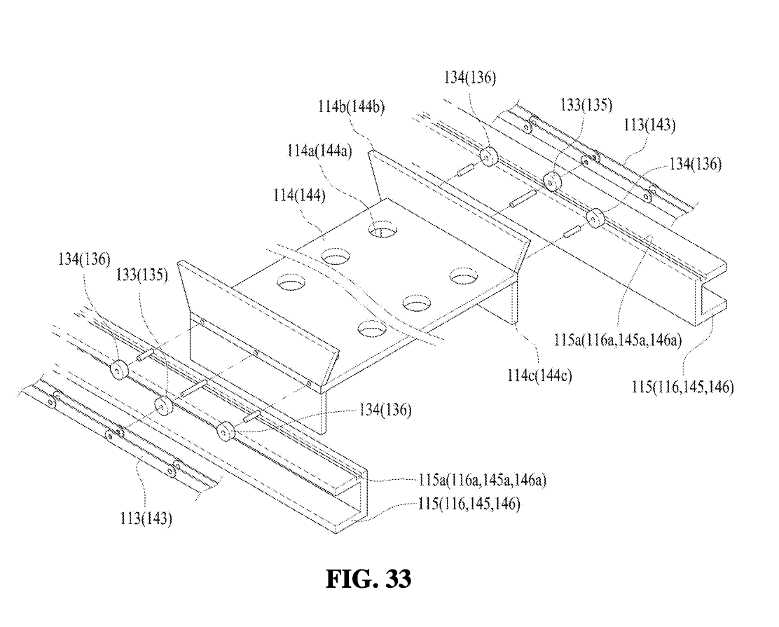

Meanwhile, a sixth embodiment of an apparatus for adjusting steam pressure in the system for drying coal using reheat steam according to the present invention will be described with reference to FIGS. 31 to 35. The sixth embodiment includes a configuration and a structure that drops and supplies the coal pile transferred on the transfer plate to the transfer plate of the lower dryer in the multi-stage dryer in addition to the configuration and the structure of the transfer plate.

In FIGS. 31 and 32, the first exhaust gas chamber 124 is installed on the first guide rail 115, the second exhaust gas chamber 126 is installed on the second guide rail 116, the third gas chamber 154 is installed on the third guide rail 145, and the fourth gas chamber 156 is installed on the fourth guide rail 146. One or more first exhaust gas chambers 124 to fourth exhaust gas chambers 156 may be partitioned and installed. The first exhaust gas chamber 124 to the fourth exhaust gas chamber 156 collect exhaust gas injected and thereafter, changed in the first steam chamber 120 to the fourth steam chamber 156, respectively and thereafter, discharged to the outside through the first gas discharge pipe 125 or the second gas discharge pipe 155.

Moreover, the first steam chamber 120 is installed below the first guide rail 115 and the second steam chamber 124 is installed below the second guide rail 116. Moreover, the third steam chamber 150 is installed below the third guide rail 145 and the fourth steam chamber 153 is installed below the fourth guide rail 146. One or more first steam chambers 120 to fourth steam chambers 153 may be partitioned and installed.

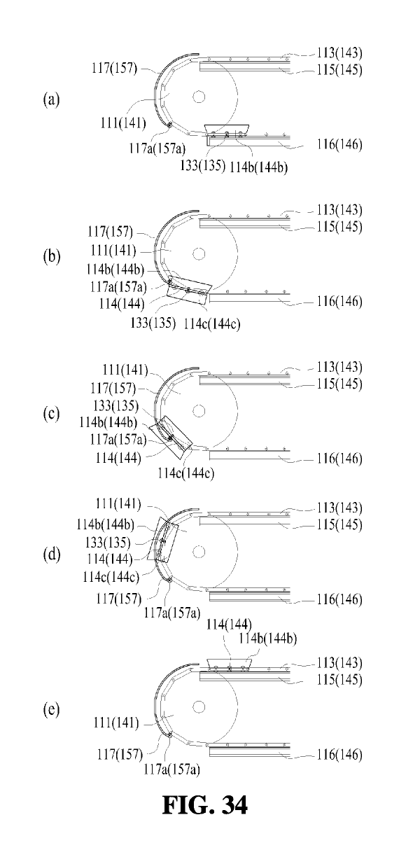

In FIG. 33, first transfer rollers 133 are hinge-coupled between two-side centers of the first transfer plate 114 and the second chains 113, respectively. That is, the first transfer roller 133 is hinge-coupled between the lateral center of the first transfer plate 114 and the first chain 113. In addition, at left and right sides of the first transfer roller 133, first auxiliary rollers 134 are hinge-coupled with the sides of the first transfer plate 114, respectively. The first auxiliary rollers 134 are hinge-coupled with the sides of the second transfer plate 114, that is, the left side and the right side, respectively.

Moreover, a groove 115a and a groove 116a guiding rotation of the first transfer roller 133 and the first auxiliary roller 134 are formed on the surfaces of the first guide rail 115 and the second guide rail 116, respectively. Accordingly, the first transfer roller 133 and the first auxiliary roller 134 hinge-coupled with the first transfer plate 114 are transferred along the groove 115a formed on the surface of the first guide rail 115 and the groove 116a formed on the surface of the second guide rail 116.

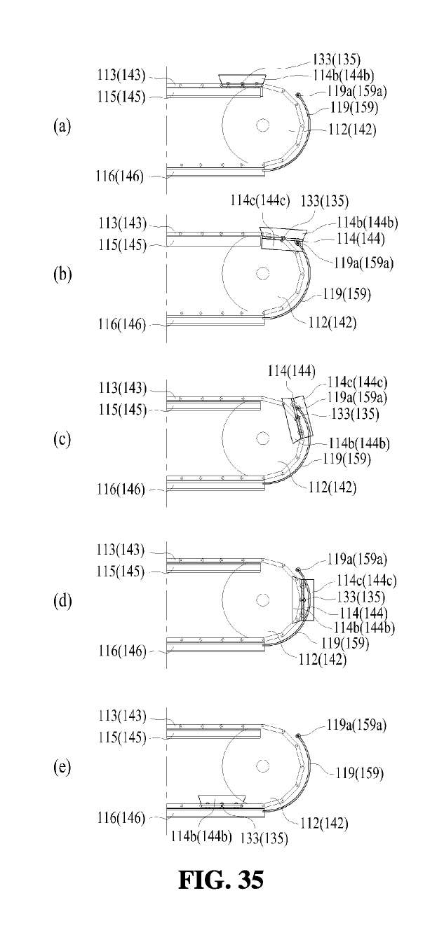

Meanwhile, in FIGS. 34 and 35, a first guide bar 117 rotating and up-supporting the lower first transfer plate 114 separated from the second guide rail 116 in one direction is installed from the top to the bottom of the first drive sprocket 111 along the side. A first trigger 117a is coupled to the end of the first guide bar 117 and the first trigger 117a is constituted by an axial rotating roller. The first trigger 117a is installed at a position which is in contact with one side of the bottom of the upper second transfer plate 114.

Further, a second guide bar 119 rotating and down-supporting the upper first transfer plate 114 separated from the first guide rail 114 is installed from the bottom to the top of the first driven sprocket 112 along the side. A second trigger 119a is coupled to the end of the second guide bar 119 and the second trigger 119a is constituted by the axial rotating roller. The second trigger 119a is installed at a position which is in contact with one side of a plane of the lower first transfer plate 114.

In addition, in the second coal dryer 140, a pair of second drive sprockets 141 and a pair of second driven sprockets 142 are spaced apart from each other at a predetermined distance to be fastened to second chains 143, respectively, a plurality of transfer plates 144 is hinge-coupled between the second chains 143, a pair of second guide rails 145 horizontally supporting the second transfer plate 144 is installed below an upper second chain 143a connected between the second drive sprocket 141 and the second driven sprocket 142, a pair of second guide rails 146 horizontally supporting the second transfer plate 144 is installed below a lower second chain 143b connected between the second drive sprocket 141 and the second driven sprocket 143, a third steam chamber 150 injecting reheat steam supplied from the reheater 500 is installed below the upper second chain 143a, a fourth steam chamber 153 injecting reheat steam supplied from the reheater 500 is installed below the lower second chain 143b, a third exhaust gas chamber 154 collecting exhaust gas is installed on the upper second chain 143a, and a fourth exhaust gas chamber 156 collecting exhaust gas is installed on the lower second chain 143b.

Further, in FIG. 33, the first transfer rollers 135 are hinge-coupled between both centers of the second transfer plate 144 and the second chains 113, respectively. That is, the second transfer roller 135 is hinge-coupled between the lateral center of the second transfer plate 144 and the second chain 143. In addition, at left and right sides of the second transfer roller 135, second auxiliary rollers 136 are hinge-coupled with the sides of the second transfer plate 144, respectively. The second auxiliary rollers 136 are hinge-coupled with the sides, that is, the left side and the right side of the second transfer plate 144.

Further, a groove 145a and a groove 146a guiding rotation of the second transfer roller 135 and the second auxiliary roller 136 are formed on the surfaces of the third guide rail 145 and the fourth guide rail 146, respectively. Accordingly, in the second transfer plate 144, the second transfer roller 135 and the second auxiliary roller 136 hinge-coupled with each other are transferred along the groove 145a formed on the surface of the third guide rail 145 and the groove 146a formed on the surface of the fourth guide rail 146.

Meanwhile, in FIGS. 34 and 35, a third guide bar 157 rotating and up-supporting the lower second transfer plate 144 separated from the fourth guide rail 146 in one direction is installed from the top to the bottom of the second drive sprocket 141 along the side. A third trigger 157a is coupled to the end of the third guide bar 157 and the third trigger 157a is constituted by the axial rotating roller. The third trigger 157a is installed at a position which is in contact with one side of the bottom of the upper second transfer plate 144.

Further, a fourth guide bar 159 rotating and down-supporting the upper second transfer plate 144 separated from the third guide rail 145 is installed from the bottom to the top of the second driven sprocket 142 along the side. A fourth trigger 159a is coupled to the end of a fourth guide bar 159 and the fourth trigger 159a is constituted by the axial rotating roller. The fourth trigger 159a is installed at a position which is in contact with one side of the plane of the lower second transfer plate 144.

In addition, in the first transfer plate 114, a plurality of through-holes 114a is formed so that the reheat steam injected from the first steam chamber 120 and the second steam chamber 123 passes through the first transfer plate 114 to contact the coal particles. At upper left and right sides of the first transfer plate 114, a guard 114b having a predetermined height is installed to prevent the input coal pile from flowing in a left or right direction of the first transfer plate 114. The guard 114b has a shape that is wide at the top and narrow at the bottom as a substantially trapezoidal shape. Accordingly, the top of the guard 114b of the first transfer plate 114 is overlapped with an adjacent guard 114b. In this case, the guard 114b of the first transfer plate 114 is installed in a substantially zigzag direction with the adjacent guard 114b. Further, at lower left and right sides of the first transfer plate 114, shield plates 114c are installed to prevent the reheat steam injected from the first steam chamber 120 and the second steam chamber 123 from being lost when injected to left and right sides of each of the first steam chamber 120 and the second steam chamber 123.

In addition, in the second transfer plate 144, a plurality of through-holes 144a is formed so that the reheat steam injected from the third steam chamber 150 and the fourth steam chamber 153 passes through the second transfer plate 144 to contact coal particles. At upper left and right sides of the second transfer plate 144, guards 144b having a predetermined height are installed to prevent the input coal pile from flowing in a left or right direction of the second transfer plate 144. The guard 144b has a shape that is narrow at the top and widened at the bottom as the substantially trapezoidal shape. Accordingly, the top of the guard 144b of the second transfer plate 144 is overlapped with an adjacent guard 144b. In this case, the guard 144b of the second transfer plate 144 may be installed in the substantially zigzag direction with the adjacent guard 144b. Further, at lower left and right sides of the second transfer plate 144, shield plates 144c are installed to prevent the reheat steam injected from the third steam chamber 150 and the fourth steam chamber 153 from being lost when injected to left and right sides of each of the third steam chamber 150 and the fourth steam chamber 153.

In addition, in FIG. 35a, the upper first transfer plate 114 is transferred to the end of the first guide rail 115 by rotating the first driven sprocket 112. In FIG. 35b, while the lower left side of the upper first transfer plate 114 deviates from the end of the first guide rail 115, the lower right side of the upper first transfer plate 114 is in contact with the second trigger 119a of the second guide bar 119. In this case, in the upper first chain 113, the upper first transfer plate 114 hinge-coupled to the first transfer roller 133 is separated from the first guide rail 115 and simultaneously rotates in a left direction of the first transfer roller 133 as an axis to drop down the loaded coal pile. In addition, in FIG. 35c, the bottom of the upper first transfer plate 114 moves downward along the second trigger 119a. In FIG. 35d, the upper first transfer plate 114 is maintained in a substantially vertical state and moves without pivoting along a rotation radius of the first driven sprocket 112 while the bottom contacts the second guide bar 119. In FIG. 35e, while the upper first transfer plate 114 transferred downward moves up to the second guide rail 116, the coal pile dropped down from the first transfer plate along the lower first transfer plate 114 is loaded and transferred. In addition, the coal pile loaded on the lower first transfer plate 114 is transferred and dried by the reheat steam.

Next, in FIG. 34a, the lower first transfer plate 114 is transferred to the end of the second guide rail 116 by rotating the first drive sprocket 111. In FIG. 34b, while the lower right side of the lower first transfer plate 114 deviates from the end of the second guide rail 116, the planar left side of the lower first transfer plate 114 is in contact with the first trigger 117a of the first guide bar 117. In this case, in the lower first chain 113, the lower first transfer plate 114 hinge-coupled to the first transfer roller 133 is separated from the second guide rail 116 and simultaneously rotates in a left direction of the first transfer roller 133 as an axis to drop down the loaded coal pile. In addition, in FIG. 34c, the plane of the upper first transfer plate 114 moves upward along the first trigger 117a. In FIG. 34d, the lower first transfer plate 114 is maintained in a substantially vertical state and moves without pivoting along the rotation radius of the first drive sprocket 111 while the plane contacts the first guide bar 117. In FIG. 34e, while the lower first transfer plate 114 transferred upward moves upward of the first guide rail 115, the lower first transfer plate 114 becomes the upper first transfer plate 114, and as a result, the coal pile input from the coal constant feeder 400 with a predetermined amount along the upper first transfer plate 114 is loaded and transferred. In addition, the coal pile loaded on the upper first transfer plate 114 is transferred and dried by the reheat steam. The coal pile dropped from the lower first transfer plate 114 is discharged to an outlet 131 along a first slope 139.

Further, the coal pile dropped from the first coal dryer 110 to the outlet 131 is input to an inlet 160 of the second coal dryer 140, input on the surface of the second transfer plate 144 of the second coal dryer 140, and then transferred. In addition, the coal pile loaded on the upper second transfer plate 144 is transferred and dried by the reheat steam.

The transfer process of coal in the second coal dryer 140 is the same as the transfer process of the first coal dryer 110. In addition, the coal pile dropped from the lower second transfer plate 144 is discharged to an outlet 161 along a second slope 149. In addition, the coal pile dropped from the second coal dryer 140 to the outlet 161 is naturally dried while being supplied and transferred to the third coal dryer 170.

In the present invention, the steam supply pipe 121 supplying hot reheat steam generated from the reheater 500 is connected to one side of the first steam chamber 120 and the second steam chamber 123, and the steam supply pipe 151 supplying hot reheat steam generated from the reheater 500 is connected to one side of the third steam chamber 150 and the fourth steam chamber 153. In addition, a perforated plate 10 for first steam distribution through-formed with a plurality of first steam injection holes 11 is coupled to and installed in the inner upper part of each of the first steam chamber 120, the second steam chamber 123, the third steam chamber 150, and the fourth steam chamber 153. In each of the first steam chamber 120 to the fourth steam chamber 153, the reheat steam having uniform pressure is injected through the first steam injection holes 11.

The apparatus for adjusting steam pressure in the system for drying coal using reheat steam according to the present invention is configured to inject the high-temperature reheat steam at uniform pressure through the plurality of through-holes which penetrate on the transfer plate while transferring the coal for drying onto the plurality of transfer plates transferring the coal to effectively dry the coal by depriving the moisture included in the coal and has an advantage in that the high-temperature reheat steam evenly contacts the coal particles and the porosity.

While the present invention has been described with respect to the specific embodiments, it will be apparent to those skilled in the art that various changes and modifications may be made without departing from the spirit and scope of the invention as defined in the following claims.

### INDUSTRIAL APPLICABILITY

In the system for drying coal using reheat steam according to the present invention, incomplete combustion of coal is prevented by removing moisture which remains on the surface and to the inside of coal which is used fuel of a thermal power plant by injecting high-temperature reheat steam onto the surface of the coal and to the inside of the coal at uniform pressure in a multi-stage coal dryer to enhance a caloric value of the coal and minimize emission of pollutant materials and enhance stability of coal supply by increasing utilization of low-grade coal having a small demand, and as a result, there is industrial applicability.

1. An apparatus for adjusting steam pressure in a system for drying coal using reheat steam including,
a first coal dryer in which a pair of first drive sprockets and a pair of first driven sprockets are spaced apart from each other at a predetermined distance to be fastened to first chains, respectively, a plurality of transfer plates is hinge-coupled between the first chains, a pair of first guide rails horizontally supporting the first transfer plate is installed below an upper second chain connected between the first drive sprocket and the first driven sprocket, a pair of second guide rails horizontally supporting the first transfer plate is installed below a lower first chain connected between the first drive sprocket and the first driven sprocket, a first steam chamber injecting reheat steam supplied from a reheater is installed below the upper first chain, a second steam chamber injecting reheat steam supplied from the reheater is installed below the lower first chain, a first exhaust gas chamber collecting exhaust gas is installed on the upper first chain, and a second exhaust gas chamber collecting exhaust gas is installed on the lower first chain, and
a second coal dryer in which a pair of second drive sprockets and a pair of second driven sprockets are spaced apart from each other at a predetermined distance to be fastened to second chains, respectively, a plurality of transfer plates is hinge-coupled between the second chains, a pair of second guide rails horizontally supporting the second transfer plate is installed below an upper second chain connected between the second drive sprocket and the second driven sprocket, a pair of second guide rails horizontally supporting the second transfer plate is installed below a lower second chain connected between the second drive sprocket and the second driven sprocket, a third steam chamber injecting reheat steam supplied from the reheater is installed below the upper second chain, a fourth steam chamber injecting reheat steam supplied from the reheater is installed below the lower second chain, a third exhaust gas chamber collecting exhaust gas is installed on the upper second chain, and a fourth exhaust gas chamber collecting exhaust gas is installed on the lower second chain,
coal which is primarily dried in the first coal dryer being inputted into the second coal dryer and thus secondarily dried, wherein:
a steam supply pipe supplying the reheat steam generated by a reheater is connected to one side of each of the first steam chamber, the second steam chamber, the third steam chamber, and the fourth steam chamber and a first steam distribution perforated plate with a plurality of steam injection holes is coupled to and installed in the inner upper part of each of the first steam chamber, the second steam chamber, the third steam chamber, and the fourth steam chamber to inject the reheat steam at uniform pressure through the first steam injection holes.

2. An apparatus for adjusting steam pressure in a system for drying coal using reheat steam including,
a first coal dryer in which a pair of first drive sprockets and a pair of first driven sprockets are spaced apart from each other at a predetermined distance to be fastened to first chains, respectively, a plurality of transfer plates is hinge-coupled between the first chains, a pair of first guide rails horizontally supporting the first transfer plate is installed below an upper second chain connected between the first drive sprocket and the first driven sprocket, a pair of second guide rails horizontally supporting the first transfer plate is installed below a lower first chain connected between the first drive sprocket and the first driven sprocket, a first steam chamber injecting reheat steam supplied from a reheater is installed below the upper first chain, a second steam chamber injecting reheat steam supplied from the reheater is installed below the lower first chain, a first exhaust gas chamber collecting exhaust gas is installed on the upper first chain, and a second exhaust gas chamber collecting exhaust gas is installed on the lower first chain,
a second coal dryer in which a pair of second drive sprockets and a pair of second driven sprockets are spaced apart from each other at a predetermined distance to be fastened to second chains, respectively, a plurality of transfer plates is hinge-coupled between the second chains, a pair of second guide rails horizontally supporting the second transfer plate is installed below an upper second chain connected between the second drive sprocket and the second driven sprocket, a pair of second guide rails horizontally supporting the second transfer plate is installed below a lower second chain connected between the second drive sprocket and the second driven sprocket, a third steam chamber injecting reheat steam supplied from the reheater is installed below the upper second chain, a fourth steam chamber injecting reheat steam supplied from the reheater is installed below the lower second chain, a third exhaust gas chamber collecting exhaust gas is installed on the upper second chain, and a fourth exhaust gas chamber collecting exhaust gas is installed on the lower second chain, and
a coal constant feeder including a first transfer roller hinge-coupled between two-side centers of the first transfer plate and the first chains, respectively, at left and right sides of the first transfer roller, first auxiliary rollers hinge-coupled with the sides of the first transfer plate, respectively, second transfer rollers hinge-coupled between both centers of the second transfer plate and the second chains, respectively, at left and right sides of the second transfer roller, second auxiliary rollers hinge-coupled with the sides of the second transfer plate, respectively, a first guide bar rotating and up-supporting the lower first transfer plate separated from the second guide rail in one direction installed from the top to the bottom of the first drive sprocket along the side, a second guide bar rotating and down-supporting the upper first transfer plate separated from the first guide rail installed from the bottom to the top of the first driven sprocket along the side, a third guide bar rotating and up-supporting the lower second transfer plate separated from the fourth guide rail in one direction installed from the top to the bottom of the second drive sprocket along the side, and a fourth guide bar rotating and down-supporting the upper second transfer plate separated from the third guide rail installed from the bottom to the top of the second driven sprocket along the side and supplying coal of a predetermined amount onto the upward surface of the first transfer plate,
coal which is primarily dried in the first coal dryer being inputted into the second coal dryer and thus secondarily dried, wherein:
a steam supply pipe supplying the reheat steam generated by a reheater is connected to one side of each of the first steam chamber, the second steam chamber, the third steam chamber, and the fourth steam chamber and a first steam distribution perforated plate with a plurality of steam injection holes is coupled to and installed in the inner upper part of each of the first steam chamber, the second steam chamber, the third steam chamber, and the fourth steam chamber to inject the reheat steam at uniform pressure through the first steam injection holes.

3. The apparatus for adjusting steam pressure in a system for drying coal using reheat steam of claim 1, wherein a perforation ratio of the first steam injection holes to an entire area of the first steam distribution perforated plate is 10 to 15%.

4. The apparatus for adjusting steam pressure in a system for drying coal using reheat steam of claim 1, wherein a first stopper horizontally supporting the first steam distribution perforated plate is installed on each of the inner walls of the first to fourth steam chambers to protrude.

5. The apparatus for adjusting steam pressure in a system for drying coal using reheat steam of claim 1, wherein a first support member is fixed to a first fixation member provided on the bottom of the first steam distribution perforated plate installed inside each of the first to fourth steam chambers, a second support member is fixed to a second fixation member provided on the bottom inside each of the first to fourth steam chambers, a plurality of elastic supports to which an elastic body having elastic force having a predetermined magnitude is coupled is installed between the first support member and the second support member, the first elastic support is installed to support the first steam distribution perforated plate to form the first space part with the first to fourth steam chambers and the first steam distribution perforated plate is lifted with steam pressure which flows in the first space part to constantly maintain reheat steam injection pressure through the first steam injection holes.

6. The apparatus for adjusting steam pressure in a system for drying coal using reheat steam of claim 5, wherein a pocket covers the outer periphery of the first elastic support.

7. The apparatus for adjusting steam pressure in a system for drying coal using reheat steam of claim 1, wherein a second steam distribution perforated plate where a plurality of second steam injection holes is formed to penetrate is installed on the top or the bottom of the first steam distribution perforated plate installed in each of the first to fourth steam chambers.

8. The apparatus for adjusting steam pressure in a system for drying coal using reheat steam of claim 7, wherein the perforation ratio of the second steam injection holes to the entire area of the first steam distribution perforated plate is 10 to 15%.

9. The apparatus for adjusting steam pressure in a system for drying coal using reheat steam of claim 7, wherein a second stopper horizontally supporting the second steam distribution perforated plate is installed on each of the inner walls of the first to fourth steam chambers to protrude.

10. The apparatus for adjusting steam pressure in a system for drying coal using reheat steam of claim 7, wherein a first support member is fixed to a third fixation member provided on the bottom of the second steam distribution perforated plate, a second support member is fixed to a fourth fixation member provided on the surface of the first steam distribution perforated plate, a plurality of second elastic supports to which an elastic body having elastic force having a predetermined magnitude is coupled is installed between the first support member and the second support member, the second elastic support is installed to support the second steam distribution perforated plate to form the second space part with the first steam distribution perforated plate, and the second steam distribution perforated plate is lifted with steam pressure which flows in the second space part to constantly maintain reheat steam injection pressure through the second steam injection holes.

11. The apparatus for adjusting steam pressure in a system for drying coal using reheat steam of claim 10, wherein the pocket covers the outer periphery of the second elastic support.

12. The apparatus for adjusting steam pressure in a system for drying coal using reheat steam of claim 1, wherein guards are integrally coupled to left and right tops of the transfer plates, shield plates are integrally coupled to left and right bottoms of the transfer plates, one side of a steam pressure adjuster having elasticity is fixedly installed on each of both side walls of the steam chamber installed below the transfer plates, and when the steam pressure of the reheat steam transferred from the steam chamber is equal to or more than the predetermined pressure while the surface of the steam pressure adjuster contact the bottoms of the shield plates, the steam pressure presses the steam pressure adjuster having the elasticity to discharge the reheat steam between the steam pressure adjuster and the shield plates.

13. The apparatus for adjusting steam pressure in a system for drying coal using reheat steam of claim 12, wherein the steam pressure adjuster is constituted by an elastic member having the elasticity in a plate shape or a U shape.

14. The apparatus for adjusting steam pressure in a system for drying coal using reheat steam of claim 12, wherein the steam pressure adjuster is hinge-coupled to a fixation plate of which one side is fixed to each of both side walls of the steam chamber, an operation plate of which the surface contacts the bottom of the shield plate, and the other side of the fixation plate and one side of the operation plate to be elastically supported by a spring.

15. The apparatus for adjusting steam pressure in a system for drying coal using reheat steam of claim 1, wherein a steam pressure adjuster is installed, in which a guide plate in which guards are integrally coupled to the left and right tops of the transfer plates, the shield plates are integrally coupled to the left and right bottoms of the transfer plates, one side is fixedly installed on each of both side walls of the steam chamber installed below the transfer plates, a long hole is formed at the center, and a plurality of through-holes are formed at both sides of the long hole at a predetermined interval, an operation member installed on the top of the guide plate to contact the shield plates, an elevation plate formed to protrude downward on the bottom of the operation member and elevated while being inserted into the long hole, and a plurality of guide rods formed to protrude downward on the bottom of the operation member and elevated while being inserted into the through-hole and elastically supported by the spring between the bottom of the operation member and the surface of the guide plate are coupled to each other, and when the steam pressure of the reheat steam transferred from the steam chamber is equal to or more than the predetermined pressure while the surface of the steam pressure adjuster contact the bottoms of the shield plates, the steam pressure presses the steam pressure adjuster having the elasticity to discharge the reheat steam between the steam pressure adjuster and the shield plates, thereby adjusting the steam pressure at predetermined pressure or more.

16. The apparatus for adjusting steam pressure in a system for drying coal using reheat steam of claim 15, wherein one surface of the operation member contacts the side wall of the steam chamber.

17. The apparatus for adjusting steam pressure in a system for drying coal using reheat steam of claim 15, wherein an interruption protrusion is installed to protrude in an outside horizontal direction on the side wall of the steam chamber and the interruption protrusion contacts the side of the operation member.

18. The apparatus for adjusting steam pressure in a system for drying coal using reheat steam of claim 1, further comprising:
a first injection cap coupled to the respective through-holes on the first transfer plate to protrude in a cylindrical shape, having one or more first injection holes formed to penetrate on the top thereof, and a plurality of second injection holes formed to penetrate on the side thereof; and a second injection cap coupled to the respective through-holes formed on the second transfer plate to protrude in the cylindrical shape, having one or more first injection holes formed to penetrate on the top thereof, and a plurality of second injection holes formed to penetrate on the side thereof, wherein the first injection cap disperses and injects the reheat steam injected by each of the first steam chamber and the second steam chamber to the top and the side by penetrating a coal pile loaded and transferred onto the upward surface of the upper and lower first transfer plates, and the second injection cap disperses and injects the reheat steam injected by each of the third steam chamber and the fourth steam chamber to the top and the side by penetrating the coal pile loaded and transferred onto the upward surface of the upper and lower second transfer plates.

19. The apparatus for adjusting steam pressure in a system for drying coal using reheat steam of claim 18, wherein a pressure maintaining member dispersing the pressure of the reheat steam into the first injection cap and the second injection cap is coupled to each support piece.

20. The apparatus for adjusting steam pressure in a system for drying coal using reheat steam of claim 1, wherein a plurality of branched distribution steam supply pipes is connected to the first to fourth steam chambers.
